(19) United States
(12) Patent Application Publication
(10) Pub. No.: US 2025/0073949 A1
(43) Pub. Date: Mar. 6, 2025

(54) SYSTEM AND METHOD OF COEXTRUDING A HEMP COMPOSITE BOARD USING HEMP FEEDSTOCKS

(71) Applicants: John D. Graham, Portland, OR (US); John J. Bradley, Harlingen, TX (US)

(72) Inventors: John D. Graham, Portland, OR (US); John J. Bradley, Harlingen, TX (US)

(21) Appl. No.: 18/278,958

(22) PCT Filed: May 26, 2023
(86) PCT No.: PCT/US23/23773

§ 371 Date: Aug. 25, 2023

Related U.S. Application Data
(60) Provisional application No. 63/404,344, filed on Sep. 7, 2022.
(60) Provisional application No. 63/440,357, filed on Jan. 20, 2023.

(51) Int. Cl. B27N 3/28; B27N 3/00; B27N 3/04; B27N 3/08; B27N 3/18

(52) U.S. Cl. CPC B27N 3/28; B27N 3/005; B27N 3/04; B27N 3/086; B27N 3/18

(57) ABSTRACT

A method for producing environmentally friendly, coextruded hemp composite board (CHB) is provided. By using hemp fiber and hemp hurd in combination with virgin and/or recycled thermoplastics, the system and method may be used to create environmentally sound substitutes for traditional construction materials. The method generally comprises steps of obtaining hemp hurd/fiber and injecting said hemp hurd/fiber into an extruder along with a thermoplastic binder. Waste products from other production streams may be added as well to reduce waste/cost of said production streams. The resulting CHB is structurally superior to traditional construction materials largely due to the dispersed hemp hurd and hemp fiber, their encapsulation in a binder material and lower hygroscopic properties. Additionally, since the CHB is created using an extruder, a downstream extrusion arrangement may be used to mold the CHB into shapes that are difficult to achieve with traditional construction materials.

### CROSS-REFERENCE TO RELATED APPLICATIONS

This application claims the benefit of U.S. Provisional Application Ser. No. 63/404,344, filed on Sep. 7, 2022, and U.S. Provisional Application Ser. No. 63/440,357, filed on Jan. 20, 2023, and International Application Serial No. PCT/US23/23773, filed on May 26, 2023, which are incorporated herein in their entirety by reference.

### FIELD OF THE DISCLOSURE

The subject matter of the present disclosure refers generally to an extrusion process for creating a coextruded composite board using hemp feedstocks.

### BACKGROUND

The three dominant construction boards used in building construction and remodeling have been primary building ingredients for decades. Plywood began to be used in the United States as a general building material in the 1920' and 30's for prefabricated houses focused on quick fabrication and easy disassembly and low cost. Drywall was invented in 1916. It was originally marketed as a wallboard to protect homes from urban fires, and as the poor man's alternative to plaster walls. Oriented Strand Board (OSB) was originally called waferboard and was created in the 1960's as a cheaper alternative to plywood.

Today, these three common construction boards in their various forms cover most interior and exterior walls, ceilings, roofs, and floors throughout the United States. Though each of the three boards can provide many benefits as building materials, each board has similar inherent drawbacks. The production of plywood and OSB are waste-intensive processes, emitting large amounts of wood wastes, water wastes, resin and wax wastes, and volatile emissions. Drywall production also has a noticeable environmental impact. Processing the gypsum releases particulates from the gypsum powder in addition to sulfur dioxide, nitrous oxide, and carbon monoxide. Heating the gypsum throughout the production process also has a high energy cost.

Each of these construction boards can degrade over their service life due to the inherent problems that exist in their material composition, process of manufacture, and product application. In particular, the hygroscopic properties of the wood pieces that comprise both plywood and OSB and the porous nature of gypsum used as the base material for drywall can make them a poor construction material choice in situations where they might be exposed to consistent patterns of moisture and humidity.

Hemp biomass is renewable, recyclable, and compostable. Hemp plants are relatively easy to grow in most climates with a fast yield, typically reaching maturity in 85-100 days. Its capability to be grown almost anywhere creates maximum flexibility for site location and the ability to minimize the transportation footprint. Hemp returns 50% of the nutrients it takes from the soil and has the highest yield per acre of any natural fiber. Importantly, hemp fiber is ten times stronger than wood fiber, is lighter and less expensive to produce.

Accordingly, there is a need in the art for a process that creates a superior quality construction board at a lower cost using sustainable ingredients to create a composite board that has improved mechanical and physical properties and addresses the shortcomings and inherent limitations of conventional construction boards.

### SUMMARY

A method for producing a coextruded hemp composite board (CHB) using hemp feedstocks is provided. In one aspect, the method may be used to create CHB from hemp fiber, hemp hurd (the cellulosic part of the hemp stalk), and binders that can be molded into different sizes and grades depending on the application. In another aspect, the method creates a hemp composite board that matches or exceeds the strength of conventional construction boards, is moisture resistant, easy to install, and sustainably sourced. In yet another aspect, the method may be used to create CHB using hemp feedstocks, a bio-based carbon, and diverse waste streams that in combination can help reduce waste and enhance carbon capture. In yet another aspect, the component mix to create CHB can be altered easily to meet different market requirements and applications. Generally, the method of the present disclosure is designed to create an environmentally sound replacement for existing construction materials by combining hemp feedstocks with virgin and/or recycled thermoplastic or other recyclable binders.

The method for creating CHB from hemp feedstocks generally comprises the steps of farming, harvesting, retting, opening, grinding, separating, classifying, screening, micronizing, filtering, mixing, extruding, curing, and post-curing processing. After harvesting, the hemp biomass typically undergoes a retting process in the field where it is grown. The retted (or unretted) hemp is baled and transported to a processing arrangement where it undergoes multiple processing steps that convert the hemp biomass into two distinct feedstocks, hemp fiber and hemp hurd. In some embodiments, the separation arrangement may be configured to separate the components into distinct product streams. In other arrangements, the components may be separated and then recombined to create a distinct feedstock with a distinct mix, preferred range, or variation of sizes/lengths in order to achieve certain properties in the final application. One skilled in the art will understand that natural materials have an inherent degree of variability, therefore the management of these feedstocks will always have a varied “range” of sizes and diameters that refinement can never completely homogenize as their very nature prohibits it.

Opening and loosening the hemp biomass begins the production process. A decortication process may follow that begins the separation of the hemp fiber from the hemp hurd. In some cases, the hemp biomass can be processed without segregation via a series of grinding and screening processes. In a preferred embodiment, the processing arrangement comprises but is not limited to an opener, decorticator, and a series of mechanical screeners, high-speed air separators and pulverizing mills. The combination of the various machines used in the processing arrangement allows for classification of hemp fibers and hemp hurd based on their length, diameter, and size to meet the ingredient requirements of manufacturing CHB.

To begin manufacturing CHB, at least one of hemp fiber and hemp hurd are injected or “fed” into one or more extruders (individually or as mixtures) of an upstream extrusion arrangement, depending on the type of coextrusion to be performed, with a binder material to create a finished CHB product. The binder material is preferably a thermoplastic/thermoset, any/other polymer binder, or natural binder/glue. In some embodiments, the hemp feedstocks may be pre-compounded with the binder material or partially compounded with the binder material. In some embodiments, the hemp feedstocks may also be pelletized for inclusion by means of a binder or pressure, or any other commonly accepted means of feeding extruders used in thermoplastic/thermoset/polymer, or other types of commercially available or custom extrusion production equipment to create the extrudate that is ultimately used to create a finished CHB product. These feedstocks are accepted by at least two extruders via throats at a first end of the extruders and the at least two extrudates are ejected at second ends of their respective extruder. In some embodiments, the feedstocks are dried prior to injection into the at least two extruders to reduce downstream issues resulting from inconsistent moisture content of materials that can be hydroscopic at ambient temperature. In some preferred embodiments, a blowing agent may be combined with the hemp feedstocks and thermoplastic/thermoset, or any polymer or other available binder to create a foamed extrudate.

Where a non-heated type of extrusion is sufficient, the feedstocks may be premixed in a dry format (partial or all raw materials) and then introduced into the extruders that create adequate shear through the use of a single or multiple screw type mixing machines. In embodiments comprising single screw extruders, the feedstocks are preferably mixed prior to being fed to said single screw extruders. In embodiments where the feedstocks are not premixed, twin screw extruders are preferably used due to greater shear created within the barrel as well as greater distributive mixing and dispersive mixing created by the action of the twin screws within the barrel; however, both single screw extruders and twin-screw extruders may be used with mixed feedstocks or unmixed feedstocks without departing from the inventive subject matter described herein. In some preferred embodiments, a blowing agent may be combined with the hemp feedstocks and binder material to create foamed extrudates. The temperature of the barrel is preferably cooled to ensure that the blowing agent does not become too hot and degrade prior to dissolving into the melted binder materials within the barrel of the extruder. Further, non-vented extruders are preferably used for any foamed extrudates to prevent expansion of the gasses dissolved within the foamed extrudates prior to injection into the manifold.

As the extrudate is ejected from a manifold of the upstream extrusion arrangement in the form of a coextruded extrudate sheet, a plurality of rollers in a downstream extrusion arrangement may be used to pull the extrudate from the upstream extrusion arrangement so that said coextruded extrudate sheet may undergo the curing and post-curing processing steps. Minute adjustments in the speed of the plurality of rollers, especially during the curing process, enable fine adjustment of dimensional characteristics and features (e.g., wall thickness, internal diameter) of the coextruded extrudate sheet. In some embodiments, at least one roller of said plurality of rollers may be configured to imprint a pattern on the coextruded extrudate sheet. As the coextruded extrudate sheet is pulled through post-extrusion processing by the plurality of rollers, cooling equipment may be used to assist with the cooling of the coextruded extrudate sheet to increase consistency of the finished CHB product. Cooling equipment used by the system may include, but is not limited to, immersion cooling tanks, vacuum cooling tanks, cooled rollers, and spray cooling tanks.

During the post curing processing step, the coextruded extrudate sheet may be further formed via machinery, depending on consistency and desired shape of the finished CHB product 625. Forming of the coextruded extrudate sheet is preferably accomplished using mechanical means, including, but not limited to pressure rollers, cutters, sanders, planers, and routers. In a preferred embodiment, a plurality of rollers will reduce the final board thickness to its final width during the curing process; however, a sander, saw, and/or router may be used after the thermoplastic/thermoset, other polymer, or natural binder/glue has set/cured the extrudate sheet to create the desired shape. After the coextruded extrudate sheet has been shaped, it may be, including but not limited to, treated, edge-coated, painted, printed, etched, or any combination thereof until the desired finished CHB product is acquired. Suction cups may be used to stack the finished CHB product for distribution.

Due to the to the use of recycled materials and sustainable hemp feedstocks, the various finished CHB products created using the methods described herein will result in a tremendous benefit to the environment when evaluated through a life cycle analysis (LCA). Finished CHB products under LCA will show that by using sustainable hemp feedstocks, reclaimed “waste” materials from construction and manufacturing processes, reduced shipping weights, and streamlined processing will dramatically offset the carbon offenses in the construction industry, and provide permanent carbon sequestration opportunities that currently do not exist today in available solutions. Additionally, the methods described herein include the possibility of including carbonized materials into the final product by using it as a feedstock, allowing for high carbon sequestration crops, such as, but not limited to, hemp and/or bamboo, to be grown and turned into bio-carbon via pyrolysis before incorporation into the process described herein as a feedstock and carbon sink. This is possible because of the unique way that finished CHB products are produced using the method described herein. As such, when compared with the traditional methods or production for traditional construction materials, the LCA will show that the finished CHB products produced by the methods described herein are not only superior in terms of carbon capture but are also more sustainable.

The foregoing summary has outlined some features of the system and method of the present disclosure so that those skilled in the pertinent art may better understand the detailed description that follows. Additional features that form the subject of the claims will be described hereafter. Those skilled in the pertinent art should appreciate that they can readily utilize these features for designing or modifying other methods for carrying out the same purpose of the methods disclosed herein. Those skilled in the pertinent art should also realize that such equivalent modifications do not depart from the scope of the methods of the present disclosure.

### DESCRIPTION OF THE DRAWINGS

These and other features, aspects, and advantages of the present disclosure will become better understood with regard to the following description, appended claims, and accompanying drawings where:

FIG. 1 illustrates a system configured to produce CHB and embodying features consistent with the principles of the present disclosure.

FIG. 2 illustrates a separation arrangement embodying features consistent with the principles of the present disclosure.

FIG. 3 illustrates an upstream extrusion arrangement embodying features consistent with the principles of the present disclosure.

FIG. 4 illustrates a cross sectional view of an extruder embodying features consistent with the principles of the present disclosure.

FIG. 5 illustrates a downstream extrusion arrangement embodying features consistent with the principles of the present disclosure.

FIG. 6 illustrates a finished CHB product embodying features consistent with the principles of the present disclosure.

FIG. 7A is a chart illustrating physical properties of a finished CHB product as a function of the amount of hemp fiber relative to the amount of binder material used to produce said finished CHB product.

FIG. 7B is a chart illustrating physical properties of a finished CHB product as a function of the amount of hemp hurd relative to the amount of binder material used to produce said finished CHB product.

FIG. 8 is a chart illustrating edge strength of a finished CHB product as a function of the amount of hemp fiber used to produce said finished CHB product.

FIG. 9 illustrates a cross-sectional view of a coextruded extrudate sheet embodying features consistent with the principles of the present disclosure.

FIG. 10 illustrates a coextruded extrudate sheet comprising molded shapes and embodying features consistent with the principles of the present disclosure.

FIG. 11 illustrates a coextruded extrudate sheet comprising a pattern and embodying features consistent with the principles of the present disclosure.

FIG. 12 illustrates the hemp feedstock alignment within the binder material and embodying features consistent with the principles of the present disclosure.

FIG. 13 illustrates a cross-sectional view of ductwork made from coextruded hemp duct board (CHDB) and embodying features consistent with the principles of the present disclosure.

FIG. 14 illustrates how CHDB having a score and ball pattern may be used to create ductwork embodying features consistent with the principles of the present disclosure.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, steps, etc. are optionally present. For example, a system “comprising” components A, B, and C can contain only components A, B, and C, or can contain not only components A, B, and C, but also one or more other components. The term “hemp feedstocks” and grammatical equivalents thereof are used herein to mean the hemp hurd and hemp fiber obtained from hemp plants via processing. For example, a hemp-based composite may comprise a feedstock having hemp hurd, hemp fiber, and lignin, which may all be combined with a binder material to create the extrudate that forms the extrudate sheet. The term “distributive mixing” may be defined as the physical process of blending two feedstocks such that the physical separation distances are reduced to scale where diffusion can occur, leading to a more homogonous extrudate. The term “dispersive mixing” may be defined as the break-up of the minor component of a mixture into smaller size particles. The term “blowing agent” and grammatical equivalents thereof are used herein to mean additives injected into extruders along with binder feedstocks to create foamed extrudates. The term “coextrusion” and grammatical equivalents thereof are used herein to mean the method of creating an extrudate sheet having at least two layers, wherein said layers are formed from at least two extrudates or at least extrudate and a substrate.

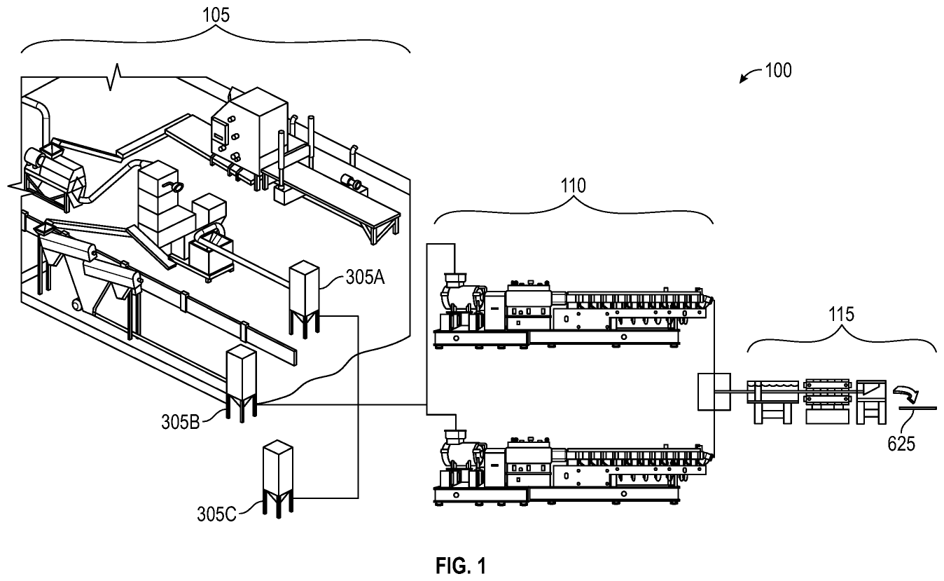

FIGS. 1-12 illustrate embodiments of a system 100 used to produce a finished coextruded hemp composite board (CHB) product as well as a method for creating said finished CHB product 625. In a preferred embodiment, the feedstocks 305 used to make finished CHB product 625 comprise hemp biomass 205 (broken down into its various components) and a binder material 305C. As illustrated in FIGS. 1-6 and 9-12, the process involves processing hemp biomass 205 into hemp fiber 305B and hemp hurd 305A before combining said hemp fiber 305B and hemp hurd 305A with a binder material 305C via at least two extruders 310 to create at least two extrudates 320 that are subsequently molded and processed into a finished CHB product 625. Screws 310D contained within the barrels 310C of the at least two extruders 310 mix and heat said feedstocks 305 via shear force created by the action of the screws 310D within the barrels 310C, resulting in extrudates 320 that are subsequently injected into a manifold 325 secured to the at least two extruders 310. The manifold 325 combines the at least two extrudates 320 and forms them via a die outlet to create a coextruded extrudate sheet 330. This coextruded extrudate sheet 330 is pulled from the extruder 310 via a plurality of rollers 505 in the form of a puller, wherein said coextruded extrudate sheet 330 is allowed to cool and undergo post extruding processing until a finished CHB product 625 is obtained.

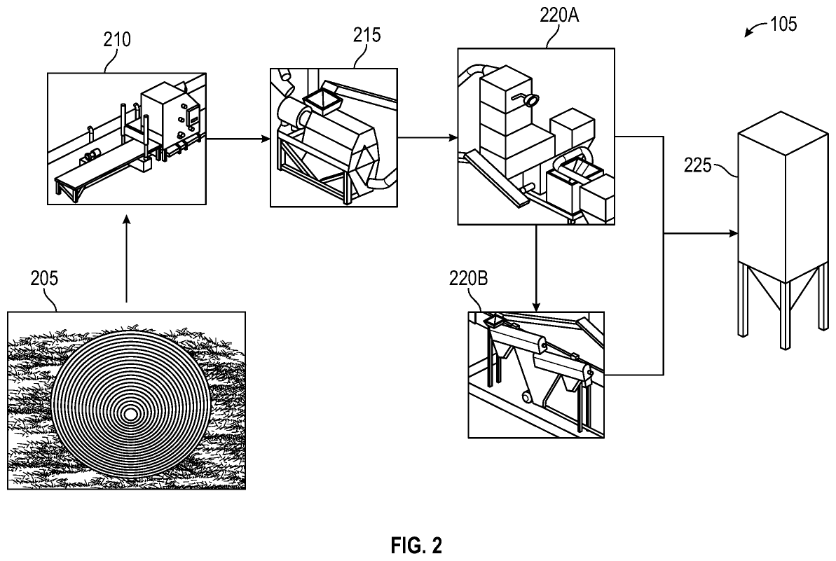

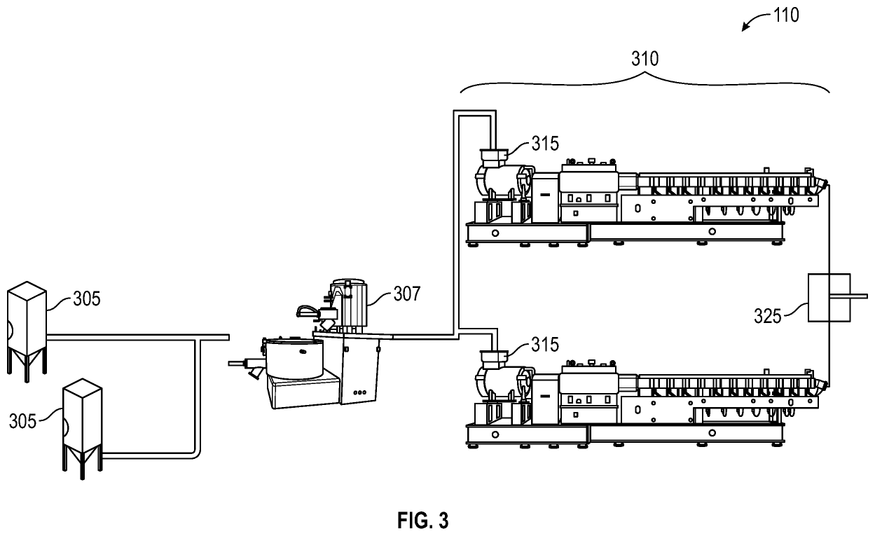

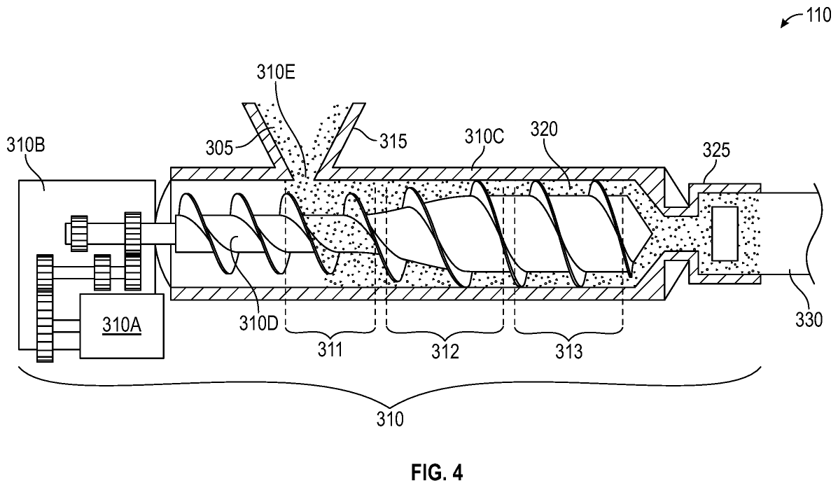

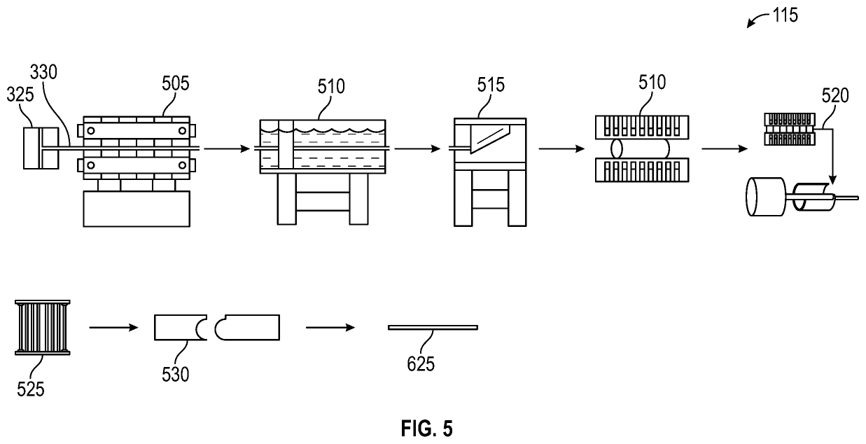

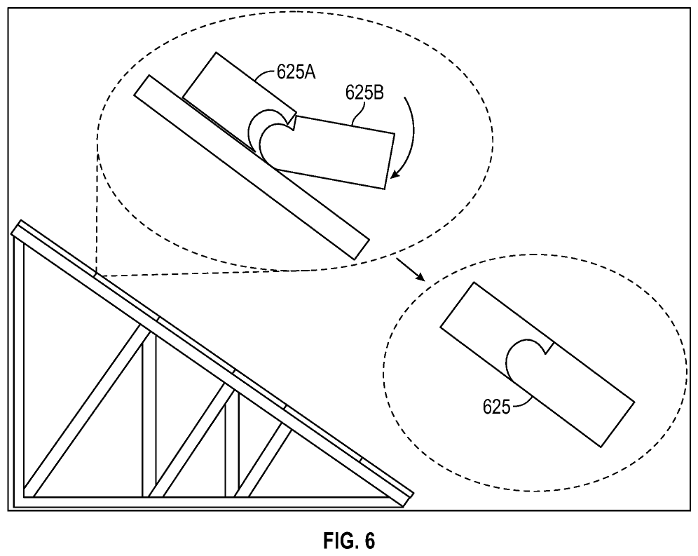

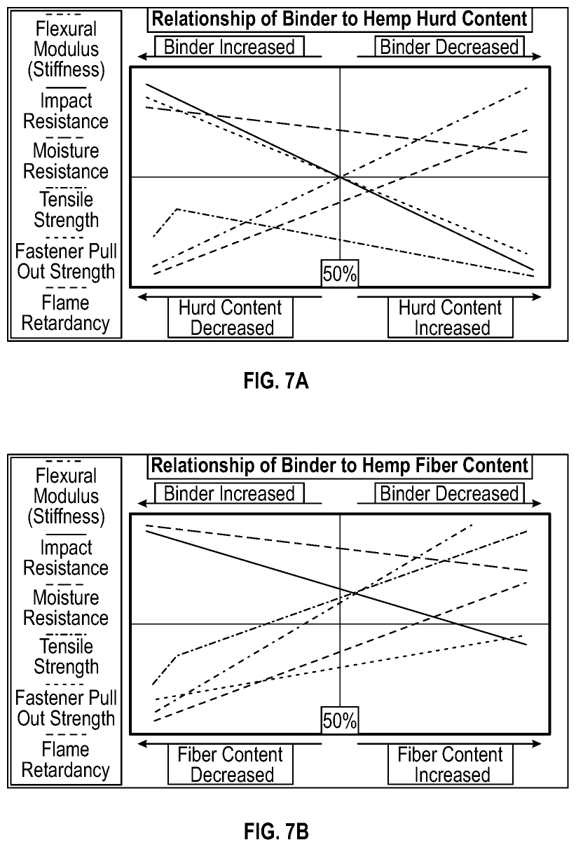

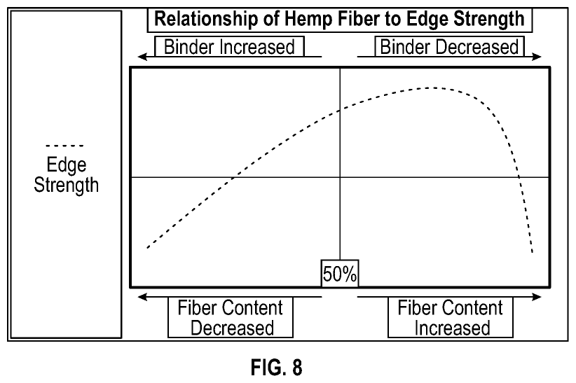

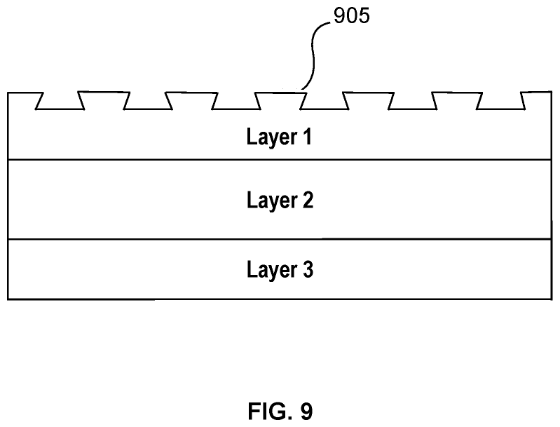

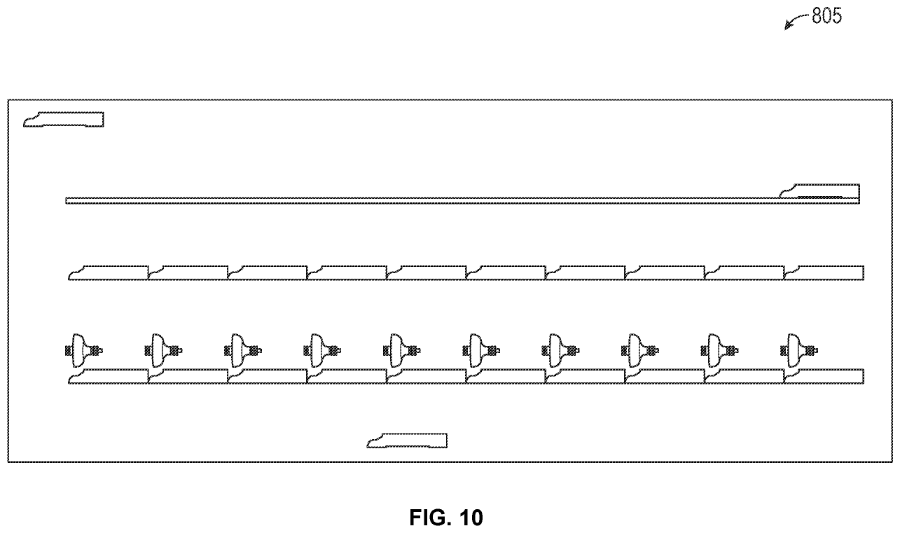

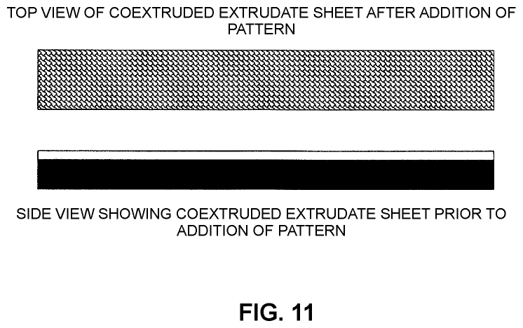

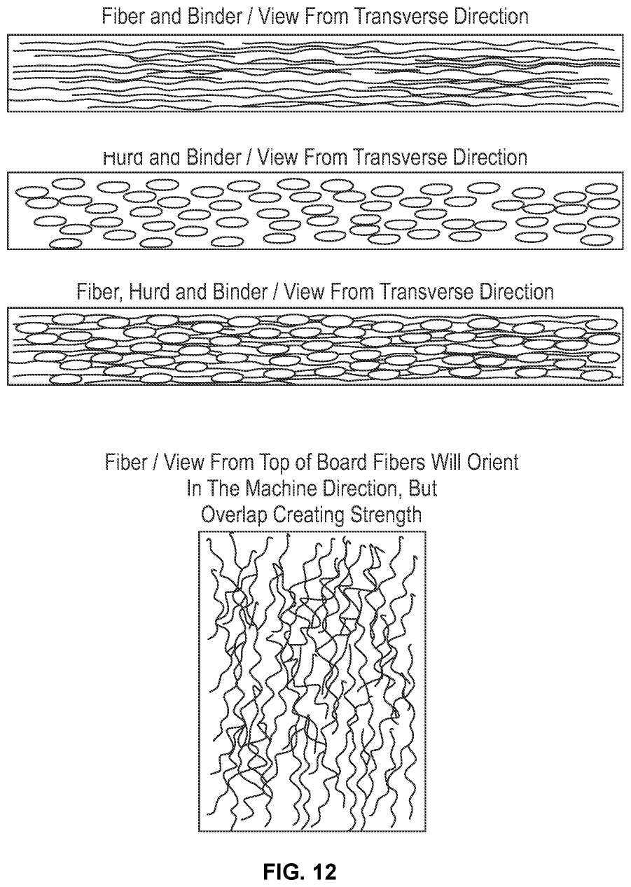

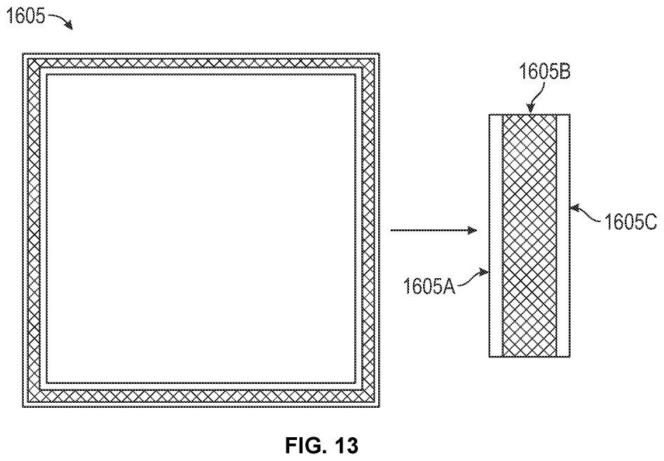

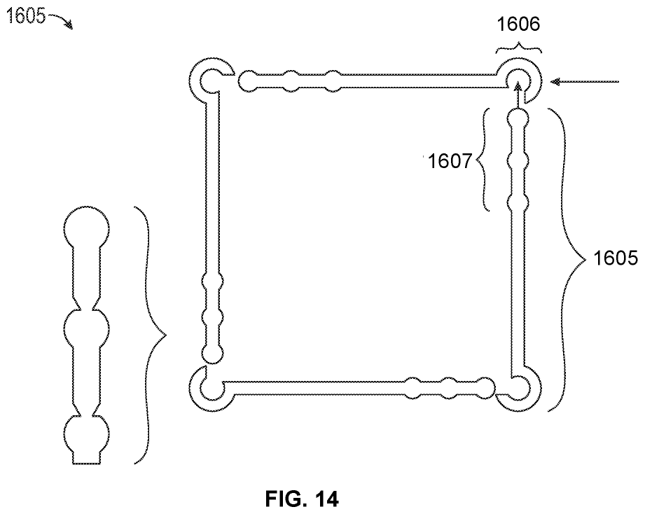

FIG. 1 is an exemplary diagram of a system 100 that may be used to produce finished CHB product 625, wherein said system 100 generally comprises a separation arrangement 105, upstream extrusion arrangement 110, and downstream extrusion arrangement 115. FIG. 2 is an exemplary diagram of the separation arrangement 105 of a system 100 used to produce the feedstocks 305 needed to make finished CHB product 625. FIG. 3 is an exemplary diagram of the upstream extrusion arrangement 110 of a system 100 used to produce the at least two extrudates 320 and coextruded extrudate sheet 330 needed to make finished CHB product 625. FIG. 4 is a cross-sectional view of an extruder 310 being used to create extrudate 320 using feedstocks 305 fed to said extruder 310 via a throat 310E of said extruder 310. FIG. 5 is an exemplary diagram of the downstream extrusion arrangement 115 of a system 100 used to produce finished CHB product 625. FIG. 6 illustrates a finished CHB product 625 product that may be used in construction. FIGS. 7A and 7B depict how physical properties of at least one layer of finished CHB product 625 may be altered by changing the amount of hemp feedstock 305 used relative the amount of binder material. FIG. 8 depicts how edge strength of at least one layer of finished CHB product 625 may be altered by changing the amount of hemp fibers 305B used to produce the extrudate 320. FIG. 9 depicts a cross-sectional view of a coextruded extrudate sheet 330 comprising a plurality of micro-grooves. FIG. 10 illustrates a coextruded extrudate sheet 330 comprising a plurality of molded shapes. FIG. 11 illustrates a coextruded extrudate sheet 630 before and after the application of a pattern 905. FIG. 12 illustrates the alignment of hemp feedstocks within the extrudate sheet 330 after ejection of the extrudate 320 from the upstream extrusion arrangement 110. FIG. 16 illustrates a cross-sectional view of ductwork of a heating, ventilation, and air conditioning system (HVAC) that is made from coextruded hemp duct board (CHDB) 1605. FIG. 17 illustrates how CHDB 1605 having a “score and ball” pattern 1607 may be fitted together using hook ends 1606 to create ductwork. It is understood that the various method steps associated with the methods of the present disclosure may be carried out by a user using the system 100 illustrated in FIGS. 1-6 and 9-14.

Industrial hemp fiber 305B is one of the strongest and stiffest available natural fibers and therefore has a great potential for use as a reinforcement in composite materials used for construction. Hemp fiber 305B has a relatively low production cost and is more eco-friendly compared to other materials used in construction due to hemps natural ability to capture carbon as well as its inherent biodegradability. Additionally, hemp hurd 305A and hemp fiber 305B have a lower density than glass fiber but are still able to create strong bonds with the polymer matrix of a binder material 305C comprising a polymer binder. As such, using hemp feedstocks to create construction materials results in materials that exceed the physical and mechanical properties of many wood-based construction materials. In addition, non-foamed finished CHB products 625 containing a total of ˜40% or more hemp feedstock by volume will be lighter than the traditional construction material equivalent. Foamed finished CHB products 625 can possess as little as 5% hemp feedstock and be lighter than its equivalent traditional construction material. For example, a 4′×8′ sheet of a finished CHB product 625 optimized for wallboard comprising a first layer 1605A containing 50% hemp feedstock by volume and 50% binder material 305C by volume and a second foamed layer comprising 60% hemp feedstock by volume and 40% binder material 305C by volume will be significantly lighter than a traditional gypsum board of the same size. This could greatly reduce shipping costs of construction materials over long distances and reduce the burden of installation.

Because hemp biomass 205 is a natural product and not synthetic, the cross-sectional shapes of hemp feedstocks can show variation, which is compensated for by utilizing the broad distribution from the processing of the hemp feedstocks as an advantage to the structural integrity of the product. Further, depending on the type of binder material 305C used, there can be compatibility issues between the hydrophilic hemp feedstocks 305 and the generally hydrophobic binder materials 305C, resulting in a weaker hemp-binder matrix. Therefore, in some embodiments, the hemp feedstocks may need physical and/or chemical treatments to enhance the resulting fiber-matrix interface of the composite material. Chemical treatment of the hemp feedstocks may be particularly useful when carried out to reduce hydrophilicity. Alternatively, the hemp feedstocks can be encapsulated within a binder material 305C (such as polymethyl methacrylate (PMMA), polyvinyl chloride (PVC), polyamide (Nylon/PA), and polycarbonates (PC)) to create a hemp-based core with enhanced water resistance. This hemp-based core may be subsequently encapsulated within a nonpolar binder material (such as polyethylene (PE), polypropylene (PP), and polystyrene (PS)) to enhance water resistance. Further, water absorption by CHB can be significantly decreased by incorporating certain fillers and chemicals therein without also resulting in a decrease in strength. And coupling agents, such as maleic anhydride grafted olefins, can be used to encourage bonding between non-compatible binder materials, such as PE and PA. Water absorption by finished CHB product 625 can be significantly decreased by incorporating certain fillers and chemicals into the hemp-based composite without decrease in strength.

When the water absorption properties of hemp feedstocks can be minimized, the benefits to mechanical and physical properties that hemp feedstocks can provide over other materials becomes more apparent. First, fiber loading can provide major benefits to mechanical properties of hemp-based composite materials. An increase in the tensile stress, tensile strength, impact strength, and flexural modulus of hemp-based composite occurs as fiber content increases. And due to the high specific modulus of hemp fibers 305B, lighter materials can be made with comparable strengths to composites produced with synthetic fillers/feedstocks 305. Second, the reactive hydroxyl groups of hemp fibers 305B offer effective interaction between the fiber and binder material 305C, allowing the hemp-based composite to absorb energy during any potential impact. By fiber loading at least one layer of the hemp-based board, an increase in the tensile stress, tensile strength, impact strength, and flexural modulus can be achieved. For example, when using finished CHB product 625 as decking for a roof, the hemp-binder matrix created by the hemp feedstocks and binder material 305C encapsulating said hemp feedstocks creates a much more impact resistant material than does a construction/composite board made purely of the binder material 305C. A fiber loaded core layer could provide impact resistance while a carbon loaded top layer could provide UV resistance, fire resistance, and water proofing. The addition of a foamed bottom layer could provide insulative and acoustical benefits as well. Creating customized, region-specific roof boards is as easy as changing the feedstocks 305 and extrusion parameters, resulting in a new range of roofing material not previously possible.

Hemp feedstocks 305 can be used at various amounts to increase different physical properties and/or mechanical properties of the composite material, as illustrated in FIGS. 7 and 8. In particular, the addition of hemp fiber 305B and/or hemp hurd 305A to binder material 305C has the benefit of increasing edge strength, flexural modulus, tensile/pull strength, and screw pull strength (fastener retention). An increase in edge strength is particularly beneficial for construction materials since boards having higher edge strengths will experience less cracking during transport, installation, and long-term use. For example, finished CHB product 625 created for use as a subfloor under carpet may have a core layer comprising 30% by volume hemp feedstock and 70% by volume nonpolar, virgin polymer binder positioned between two exterior layers comprising approximately 25% by volume micronized hemp feedstock, 10% by volume bio-derived carbon, and 65% by volume nonpolar, virgin polymer binder with an amount of coupling agent to enhance bonding between the hemp feedstock encapsulated within the nonpolar, virgin polymer binder. This will result in a finished CHB product 625 subflooring material, wherein the edge strength of the exterior layers is at least as great as that of existing construction boards. Further, this finished CHB product 625 subflooring material will possess superior water resistance, pest resistance, and rot resistance properties. In a preferred embodiment, hemp hurd 305A and hemp fiber 305B loading is kept between 15% and 50% by volume to reduce discontinuity, non-homogeneity, and agglomeration of the hemp feedstocks during the extrusion process; however, as little as 5% by volume and as much as 95% by volume of hemp fiber 305B and/or hemp hurd 305A may be used without departing from the inventive subject matter described herein.

Though hemp biomass 205 has a broad range of applications for which it may be used, it is best when it is separated into its two main constituents before it is incorporated into construction/composite materials. In some embodiments, this may be made easier by degrading or removing the pectin and lignin from the hemp fiber after processing using a process called degumming. The removal of pectin and lignin may also enhance the properties of some CHB products; however, removal of pectin and lignin is not necessary to create a superior finished CHB product 625 product. Where a specific binder material may not be compatible with the pectin and lignin in the hemp fiber feedstock, those pectins and lignins can be removed to allow greater adhesion to the more cotton-like fibers that are the result of degumming hemp fiber.

Once the industrial hemp plant reaches a preferable maturity, the hemp stalks are harvested, baled 205, and transported to a processing site. In a preferred embodiment, as illustrated in FIGS. 1 and 2, the separation arrangement 105 comprises an opener 210, shredder 215, screener 220A, and air separator 220B configured to decompress, grind, segregate and mill said hemp biomass, respectively. In one preferred embodiment, hemp biomass is passed between fluted rollers that loosen the woody, cellulosic core from the hemp fiber 305B. A series of screening and air separation processes may be used to further separate the remaining hemp hurd 305A and hemp fiber 305B. In some preferred embodiments, a decorticator may be used to break apart hemp biomass into hemp hurd 305A and hemp fiber 305B. When an application requires ratios of hemp hurd 305A to hemp fiber 305B as they naturally occur, the only processes required are a series of grinding and screening steps, thereby eliminating all of the other separation processes. Further, in embodiments where only shorter hemp fibers 305B are desirable, processing machinery may be used to convert all the longer fibers into shorter fibers. In some embodiments a blend of long and short fibers may be combined as a blend to create additional beneficial properties like flexural modulus and tensile strength. The transport of the modified hemp biomass throughout the separation, screening and milling processes is preferably done via suction, but other methods of material conveyance may include, but not limited to, conveyors, blowers, manual manipulation, or any combination thereof.

In one preferred embodiment, the clusters of hemp material are cleaned via a decortication machine which segregates the various lengths of hemp biomass material into hemp hurd 305A and hemp fiber 305B using a series of paddles and combs. Once separated, the hemp hurd 305A and hemp fiber 305B are further cleaned and sized using a series of mechanical screens and air separation equipment. The various steps required to produce clean hemp hurd 305A means removing all, or a majority of the hemp fiber 305B that naturally clings to the hurd. Similarly, to produce clean fiber requires removing any hemp hurd 305A that is naturally bound and attached to the hemp fiber 305B. Once the hemp hurd 305A and hemp fiber 305B have each been processed to reach the desired level of product purity, a series of mills and screens are deployed to create the individual product sizing required to meet a market application.

Once the hemp has been processed into the desired components, these hemp feedstocks are transferred to an upstream extrusion arrangement 110 to create the one or more extrudates 320 that will be used to make the finished CHB product 625. In a preferred embodiment, the hemp feedstocks are combined with a binder material 305C (and in some embodiments other feedstocks) to create the finished CHB product 625. The binder material 305C may be a virgin binder material, post-consumer/industrial waste binder material, or a combination of the two. Types of materials that may act as the binder material include, but are not limited to, starch-based binders, polymers (Thermoplastic and Thermoset), polyester resin, phenolic resins, polyisocyanurate (PIR)), epoxy resin, polyurethane resin, ISO resin, vinyl ester resin, and methyl ethyl ketone peroxide (MEKP). In a preferred embodiment, the binder material is at least one of a thermoplastic/thermoset, epoxy binder, and non-polymer, non-epoxy binder, or any combination thereof. For example, a thermoplastic may be combined with a low temperature epoxy (LTE) to create a binder material that may be both curable and/or polymerizable, depending on the desired finished CHB product 625. In some preferred embodiments, the epoxy may be a heat cured epoxy, which may be combined with a thermoplastic having a melt temperature similar in range to the curing temperature of the epoxy.

In a preferred embodiment, the hemp fiber 305B and hemp hurd 305A are combined with a polymer binder to create the extrudate 320. The polymer binder is preferably that of a thermoplastic resin material possessing the ability to encapsulate the hemp feedstocks to reduce water absorption of the finished CHB product 625. In a preferred embodiment, thermoplastics used as a feedstock 305 to create the finished CHB product 625 include, but are not limited to polypropylene (PP) (sPP) (aPP), copolymer polypropylene/polypropylene random copolymer (PPR), Polypropylene random crystallinity temperature (PP-RCT), polyethylene (PE), linear low density polyethylene (LLDPE), ultra-high molecular weight polyethylene (UHMWPE), high density polyethylene (HDPE), low density polyethylene (LDPE), polyethylene terephthalate (PET or PETE), polyamide (Nylon/PA), acrylonitrile butadiene styrene (ABS), acrylonitrile styrene acrylate (ASA), cellulose acetate (CA), polybutylene terephthalate (PBT), polycarbonates (PC), polymethyl methacrylate (PMMA), polyvinyl chloride (PVC), polyphenylene oxide (PPO), polystyrene (PS), extruded polystyrene (XPS), styrene acrylonitrile (SAN), thermoplastic elastomer (TPE), thermoplastic urethane (TPU), ethylene propylene diene terpolymer (EPDM), polyisocyanurates (PIR), styrene butadiene styrene (SBS), phenolic resins, or any combination thereof. In some preferred embodiments, biodegradable resins may be preferred. These include but are not limited to Polyhydroxyalkanoates (PHA), Polylactic acid (PLA), Polybutylene adipate terephthalate (PBAT), or Polycaprolactone. The polymer binder may be a virgin plastic, post-consumer or post-industrial plastic, or any combination of the three.

Finished CHB products 625 created using the described method may also incorporate various waste streams to reduce cost, capture carbon, and increase environmental viability. In a preferred embodiment, waste streams that may be used as feedstock 305 include, but are not limited to, wood fines, bio-based carbon, gypsum, glass fibers, post-consumer polymers, post-industrial polymers, or any combination thereof. The use of post-consumer or post-industrial plastics may be particularly useful for applications in which slight reductions in physical and mechanical properties are acceptable due to the degradation of the polymeric material compared to that of virgin plastics. finished CHB product 625 possessing a plurality of foamed layers may be created using various combinations of these waste streams to create a customized finished CHB product 625. For example, a first foamed layer of finished CHB product 625 may comprise 5% by volume hemp feedstock, 2% by volume wood fines, 5% by volume recycled gypsum, 2% by volume recycled glass, 1% by volume bio-based carbon, and 80% by volume post-consumer plastic, and 5% virgin thermoplastic, whereas a second foamed layer may comprise 20% by volume hemp feedstock, 20% by volume recycled gypsum, and 60% by volume virgin plastic. The second layer 1605B could serve as the outward facing layer since the foamed layer comprising virgin plastic will have superior mechanical/physical properties. In addition, a paper layer may be adhered to the outward facing layer of the finished CHB product 625 during post-extrusion processing, resulting in finished CHB product 625 that looks similar to conventional drywall but possesses improved durability as well as improved acoustical, insulative, and hygroscopic properties. Flame retardants, antimicrobial agents, and other additives may be applied to the coextruded extrudate sheet during processing via the downstream extrusion arrangement to increase the performance of the finished CHB product as well as to allow the finished CHB product to conform with national, regional, and/or local building codes, as required. Additionally, this finished CHB product 625 will be an environmentally superior product compared to that of conventional drywall by using hemp feedstocks and diverse waste streams that in combination can help reduce waste and enhance carbon capture.

The blends using hemp biomass combined with those waste streams can create a variety of composite boards that exceed the standard baseline requirements in a multitude of applications that currently use plywood, particle board, MDF, ceiling tiles, fiber board, block board, hard board, insulation board, and OSB. Where a market exists for these types of manufactured wood-based boards, there is little inherent flexibility in their manufacture, and almost no flexibility in their material composition due to their need to be mass produced using very capital-intensive processes. CHB has a significant advantage over OSB and other wood-based construction boards because of its low-cost material composition and manufacturing processes. Importantly, the component mix of an CHB can be altered easily to meet different market requirements. As such, CHB can be a cost-effective alternative to current wood products in all construction applications and additionally for those markets that require customization in addition to enhanced performance.

In another preferred embodiment, feedstocks 305 in the form of additives may be added to the extruders 310 with the hemp feedstocks and binder material 305C to acquire finished CHB product 625 having properties more suitable for a specific purpose. Types of additive feedstocks 305 that may be fed to the extruder 310 include, but are not limited to, flame retardants, blowing agents, anti-static agents, UV resistance agents, impact resistance agents, coloring agents/pigments, flexural modulus agents, insecticides, fungicides, tensile strength agents, coupling agents, protective agents, or any combination thereof. The introduction of a filler, such as glass, and/or chemicals, such as maleic anhydride and stearic acid, can help counteract any increased hydrophilicity of the treated/untreated hemp feedstocks. Fillers that may be used to create the finished CHB product 625 include, but are not limited to calcium carbonate, kaolin clay, magnesium hydroxide, glass, nanofillers, or any combination thereof. And coupling agents, such as maleic anhydride grafted olefins, can be used to encourage bonding between non-compatible binder materials and hemp feedstocks. To improve the conveyance and the protection of hemp feedstocks throughout the production processes, the hemp fiber and hurd may be coated with PEG (Polyethylene glycol), GMS (Glycerol monostearate) and GTS (Glycerol tristearate). These additives may or may not be used on other non-hemp feedstocks such as wood fines and the other materials listed for use as potential non binder, natural, feedstocks. Additionally, hemp feedstocks can be carbonized to enhance sorption properties by increasing the specific surface area and surface oxygen groups of the hemp feedstocks.

Hemp fibers 305B may also be treated with chemical treatments including, but not limited to, NaOH, polyethyleneimine, Na₂SO₄, and Ca(OH)₂ to change structural features of the hemp feedstocks. Chemically changing these structural features may modify certain undesirable properties, such as hydrophilicity, and improve flame retardant properties of the resulting hemp-based composite. For example, modification of hemp feedstocks with phosphorus enhances the limiting oxygen index (LOI) of hemp-based composites, resulting in a decreased rate of heat release and increase in resistance to combustion. Further treatment with phosphines can enhance flame retardancy as well. And treatment of hemp feedstocks with water-soluble sulfonic acid derivatives can reduce surface polarity (lowering water solubility and increasing bonding strength with nonpolar substances) of the hemp feedstocks and improve their thermal stability, resulting in a stronger hemp-binder matrix when combined with a nonpolar binder material as well as improved flame resistance. For example, a finished CHB product 625 optimized for subflooring could comprise a top layer and bottom layer comprising 15% by volume of sulfonic acid derivative treated hemp feedstock, 10% by volume bio-based carbon, and 75% by volume nonpolar polymer binder in addition to a core layer comprising 35% by volume Ca(OH)₂ treated hemp feedstock and 65% by volume polar polymer binder, wherein a coupling agent is used to encourage bonding between non-compatible polymers. In addition, the resulting finished CHB product 625 subflooring material may be edge sealed during post-extrusion processing to further discourage water absorption by the middle layer. The resulting finished CHB product 625 subflooring material would be exceptionally strong, fire retardant, water resistant, and pest resistant, making it a superior subflooring material to OSB and other construction boards.

Though the feedstocks 305 may be added directly to the upstream extrusion arrangement 110 without mixing (due to the mixing that occurs within the extruder 310), some preferred embodiments of the system 100 may include a mixer 307, wherein the hemp feedstocks may be mixed and/or blended to create a finished mixed hemp feedstock at a specific ratio prior to transference to the at least two extruders 310. The resulting mixed feedstock may possess desired dispersive and distributed properties that may increase consistency of the finished CHB product 625. Mixing may be defined as the intermingling of different classes of hemp hurd 305A or hemp fiber 305B of the same length. Whereas blending may be defined as the intermingling of hemp hurd 305A and hemp fiber 305B or the intermingling of different lengths of hemp hurd 305A and/or hemp fiber 305B. Blending/mixing of hemp feedstocks may occur at various points within the separation arrangement 105 or just prior to the addition of the hemp feedstocks to the at least two extruders 310 of the upstream extrusion arrangement 110. In some preferred embodiments, a blending/mixing machine may be used to combine hemp feedstocks coming from various sources or various strains. Hemp plants from different genetic strains may have different percentages of hurd, fiber, and lignin as well as different fiber structures. By using a mixer 307 to mix hemp biomass 205 of different sources, a more consistent finished CHB product 625 may result. The objectives of mixing/blending include, but are not limited to, more consistent content quality, improved processing performance, more consistent functional properties of a finished CHB product 625, and a more uniform distribution of feedstocks 305 within the binder material 305C prior to undergoing extrusion.

In some embodiments, the hemp feedstocks may be pre-compounded or partially pre-compounded with the binder material 305C and subsequently pelletized to create feedstock pellets, which may then be added to the upstream extrusion arrangement 110. Pelletized feedstocks are mixed and compounded in a way that further increases homogeneity of the extrudate 320 due to the mixing that occurs prior to the feedstocks 305 being pelletized. Additives may be added to the upstream extrusion arrangement 110 to create custom finished CHB products 625 with similar hemp feedstock and binder material 305C compositions. In some embodiments, the feedstock pellets may further comprise additives, reducing the amount of work that must be done to manage the ratio of feedstocks/additives added to the upstream extrusion arrangement 110. The resulting finished CHB products 625 may have fewer defects as a result.

Additive feedstocks that may be pre-compounded or partially pre-compounded with the hemp feedstock and/or binder material 107C include, but are not limited to, color pigments, UV inhibitors, carbon black, flame retardants, metal nanoparticles, protective agents that protect hemp feedstocks and other feedstocks from degradation, or any combination thereof. Equipment that may be used to create pelletized feedstocks include, but are not limited to, single screw extruders, twin-screw extruders, “Banbury” type mixers, and Farrel Continuous Mixers (FCM), or any combination thereof. Though single screw, twin, screw, and “Banbury” type mixers are discussed as the means for creating the pelletized feedstocks, one skilled in the art will understand that other equipment and methods may be used to pre-compound the feedstocks without departing from the inventive subject matter described herein.

In some preferred embodiments, the method of processing the hemp fiber and/or hurd masterbatches may include a FCM (Farrel Continuous Mixer), the ideal process for large loadings of organic and inorganic materials. This process is typically used to achieve loadings of 40%-80% of non-binder feedstock materials in the total weight of pellet. This process can be used as an additional loading method as it is pre-compounded and can be added at various levels through varied loadings. This may be an “additive” approach rather than an on-site loading and works like color additives, process aids, slip agents, etc. It can also be pre-blended with a variety of polymers to achieve various mechanical properties. This also allows the ability to combine virgin polymers with recycled polymers, and any other binder with any hemp or other feedstock, or additives, in various combinations. The resulting combinations may be then blended with other binders, feedstocks, or additives to achieve differing combinations and their resultant differing mechanical and performance properties based on the CHB produced and the intended final application of the CHB.

The use of at least one mixer 307 may be particularly important when the at least two extruders 310 used have poor distributive mixing properties since a homogenous extrudate may otherwise be impossible to achieve. In some embodiments, a “Banbury” type mixer may be used prior to distribution of feedstocks to the extruder(s) to increase the level of mixing prior to extrusion. In a preferred embodiment, the transfer of feedstocks 305 to the mixer(s) 307 may be accomplished using a blower, but other methods of transfer may be used to transport feedstocks 305 to the mixer(s) 307, including, but not limited to, conveyor, suction, and manual modes of conveyance. The blower may transport the feedstocks 305 using positive pressure air flow within a transport tube, reducing the chance of contaminants being introduced during transference. In a preferred embodiment, the mixing process entails measuring a required amount of different feedstocks 305 needed to create a desired at least two extrudates 320 and mixing/blending the feedstocks 305 until a homogenous, mixed feedstock 305 is achieved. The feedstocks 305 are preferably stored in storage bins that may be refilled as the feedstocks are used. In a preferred embodiment, the feedstocks 305 combined within the mixer 307 are added to said mixer(s) 307 based on a volume percentage of each feedstock 305 needed for the desired extrudates 320. A weighing hopper may be used to measure the amount of each feedstock 305 used to create the mixed feedstock.

In one preferred embodiment, the at least two extrudates 320 may comprise a single hemp feedstock having a single desired length and/or diameter. For example, a desired length of hemp fiber 305B of 15 millimeters may yield optimal results when combined with a particular binder material 305C whereas a length of 0.5 millimeters may yield optimal results with a different binder material 305C. In another preferred embodiment, the at least two extrudates 320 may comprise a single hemp feedstock having multiple lengths and/or diameters. For example, the at least two extrudates 320 may comprise binder material 305C and a hemp feedstock comprising a mixture of hemp fibers 305B having different desired lengths and/or diameters. In yet another preferred embodiment, the at least two extrudates 320 may require different hemp feedstocks having one or more desired lengths and/or diameters. For example, the at least two extrudates 320 may comprise a combination of hemp hurd 305A, hemp fiber 305B, and binder material 305C, wherein the hemp hurd 305A and hemp fiber 305B comprise multiple desired lengths and/or diameters. These feedstocks 305 may be stored separately and added to the mixer 307 and/or at least two extruders 310 so that fine tuning of the finished CHB product 625 may be accomplished by simply changing the amount of each feedstock 305 that is added to the mixer 307 and/or at least two extruders 310.

In a preferred embodiment, hemp hurd 305A comprises a particle size of 0.003-8 millimeters, and hemp fiber 305B comprises a diameter range of 0.003-0.200 millimeters and a length range of 0.003-36 millimeters. However, hemp hurd 305A and hemp fiber 305B having other diameters and lengths may be used without departing from the inventive subject matter described herein. In the process of preparing hemp hurd 305A or hemp fiber 305B specifically for thermoplastics extrusion, the hemp hurd 305A and hemp fiber 305B can be prepared through a number of screening and reduction processes to create a more homogeneous mix. The final stage of manufacture is commonly referred to as micronizing. This is accomplished through the use of hammer mills, knife mills, sonic pulverization through sound wave, particle collision, wet milling, and other standardly accepted forms of size reduction of raw material feed stocks. Any of these micronization processes can produce a “broad range” of outputs ranging from a “sub-micron” size to larger particles that exceed 12 millimeters. The benefit of the production of a broad size range of material is that it creates greater loading of the hemp fiber 305B, hemp hurd 305A, and any other aforementioned potential feedstocks 305 to produce a more consistent finished CHB product 625. A cross sectional view of the product viewed under a microscope will show the feedstocks 305 are highly dispersed throughout the binder material 305C due to the mixing that occurs during the extrusion process. Dispersion of these different particle sizes contributes to the overall strength of the product by eliminating weak points in the board, more consistent encapsulation of the raw materials, and improved “compressive strength” of the final product. The dispersion of the varied particle sizes in the CHB will also enhance the UV resistance of the board by eliminating UV light permeation into the matrix created by blending the hemp feedstock and binder material 305C.

The feedstocks 305 (at least one of hemp hurd 305A and hemp fiber 305B and at least one binder material 305C) are preferably transferred to hoppers 315 of the at least two extruders 310 and/or mixer 307 via a loading mechanism. In a preferred embodiment, a vacuum loader is used to transfer feedstocks 305 to the upstream extrusion arrangement 110. The loading mechanism is connected to a floor-mounted material bin 225 via a conveying tube though which the vacuum loader draws up the feedstocks 305 to the hoppers 315. Once the hoppers 315 are filled, the vacuum loader stops and the material discharges into the at least two extruders 310 by way of gravity. The hoppers 315 may be loaded using timed loading cycles or filled to a predetermined level/weight/volume by means of a level/weight/volume control, which senses whether a receiver of a hopper 315 is full and switches off the conveying action of the loading mechanism when it is determined the receiver is full. In embodiments comprising mixers 307, the mixers 307 are preferably operably connected to the at least two extruders 310 and directly convey mixed feedstock to the throats 310E of the at least two extruders 310. The temperature of the feedstocks 305 may be kept within a preferred temperature range to reduce the moisture content of the feedstocks 305.

The upstream extrusion arrangement 110 generally comprises at least two hoppers 315, at least two driers, at least two extruders 310, and manifold 325. The at least two hoppers 315 are preferably shaped like tapered cones and are secured to the barrels 310C of the at least two extruders 310 at the throats 310E. The larger ends of the at least two hopper 315 comprise lids that may be opened and closed in a way to avoid potential contaminants that may otherwise enter the throats 310E with the feedstocks 305. Throat gates of the at least two hoppers 315 may be used to control the amount of feedstock 305 entering the at least two extruders 310, wherein the level of feedstock 305 is controlled by said throat gates in such a way that the amount of feedstock 305 in the at least two hoppers 315 is kept at a constant level as possible to ensure a constant output from the die outlet of the manifold 325.

The feedstocks 305 may be fed by the hopper 315 to the extruder 310 individually or as a blend of dry components. To help prevent clumping of the feedstocks 305 at the throat gate, the taper angle of the hopper 315 must be greater than the angle of repose of the material being extruded. If clumping is allowed to occur at the throat gate, an inconsistent amount of feedstock 305 may be injected into the extruder 310 over time, causing inconsistency in the quality and temperature of the extrudate 320. This in turn will result in inconsistency in quality and temperature of the coextruded extrudate sheet 330 ejected from the manifold 325, reducing the quality of the finished CHB product 625. The inner surface of the hopper 315 is preferably smooth to minimize binding of the feedstocks 305 as they enter the extruder 310, which could otherwise result in the melting of the feedstocks 305 to said inner surface. Materials that the hopper 315 may comprise include, but are not limited to, metal, glass, epoxy, polymer-coated materials or any combination thereof. A vibration device may be used to disturb the hopper 315 as the feedstock 305 as it is injected into the extruder 310, which should further prevent any clumping of feedstock 305 about the hopper 315. The temperature of the feedstock 305 should also be kept as constant as possible to increase consistency throughout the extrusion process, which may be accomplished using a heated hopper assembly.

Using a hopper heater may be used to dry the feedstocks 305 before being fed to the at least two extruders 310. This will result in the creation of at least two extrudates 320 with a more consistent moisture content. Alternatively, the feedstocks 305 may be dried in another device of the system 100, allowing the hopper heater to simply maintain the moisture content within the dried feedstocks prior to injection into the at least two extruders 310 as well as to maintain a desirable feedstock temperature. In a preferred embodiment, the hopper heater is configured to blow heated air through the base of the at least two hoppers 315 and/or mixer 307, which filters though the feedstocks 305. Some of the warm air is allowed to eject from the at least two hoppers 315 to prevent a buildup of humidity from the moisture removed from the feedstocks 305. Drying times may be reduced by using a desiccant drier or vacuum drier.

In a preferred embodiment, the at least two extruders 310 generally comprise a motor 310A, gear box 310B operably connected to the motor 310A, screw 310D operably connected to the gear box 310B, barrel 310C, and manifold 325. The at least two extruders 310 are preferably “single screw” extruders and/or “twin screw” extruders; however, “multi-screw extruders” or mechanical mixing means that include mixing within a heated chamber may be used to create finished CHB product 625 without departing from the inventive subject matter as described herein. In some preferred embodiments, a plurality of heaters and/or cooling fans may be used to help control the temperature of the at least two extrudates 320 created by the at least two extruders 310 by heating or cooling the barrel 310C of the at least two extruders 310. Screws 310D contained within the barrels 310C mix the feedstocks 305, wherein the barrels 310C have inner diameters at least as wide as the screws 310D. Feedstocks 305 are injected into the barrels 310C via throats 310E of the barrels 310C, wherein the feedstock 305 is turned into at least two extrudates 320 as it moves through said barrels 310C due to action of the screws 310D.

The at least two extrudates 320 are pushed through an opening of their respective barrel 310C and into a manifold 325, wherein a die outlet of said manifold 325 forms a coextruded extrudate sheet 330 having a desired shape that is pushed/pulled from the upstream extruding arrangement. Further, shear force created by the screws 310D within the barrels 310C as they act on the feedstocks 305/extrudates 320 forces the binder fibers/chains of the extrudates 320 to align in the output direction of the machine as they exit the die outlet of the manifold 325, resulting in a coextruded material with binder fibers/chains oriented in a single direction. Though the hemp feedstocks encapsulated within the binder material 305C will also generally align in the output direction of the machine, hemp feedstocks are highly varied in structure. This results in a composite material that is anisotropic in behavior but also possess stronger binding between layers, enhancing properties such as edge strength and pull strength.

The barrels 310C are the components of the extruders 310 that contain the screw 310D. Feedstocks 305 enter their respective barrel 310C and are compressed against the interior walls of the barrels 310C by the action of the screws 310D. The interior surfaces of the barrels 310C may be smooth or grooved; however, it is important to note that the pressure increase caused by shear occurs much faster in grooved barrels than in smooth barrels. For example, gasses created by blowing agents form much faster in grooved barrels than in smooth barrels. As such, temperatures around the throat 310E of grooved barrel extruders should be kept lower than for smooth barrel extruders as to prevent any gasses created by the blowing agent from escaping via the throat 310E.

As illustrated in FIG. 4, the screw(s) 310D of the at least two extruders 310 generally comprise tapered cylinders of metal having a cylindrical channel cut into its surface that creates a screw channel. In a preferred embodiment, the screw(s) 310D used to create the extrudate 320 containing a blowing agent are configured so that no pressure decrease occurs in the single zones of the screw 310D as to prevent pre-foaming of the extrudate 320 within the barrel 310C before it reaches the manifold 325. The screw(s) 310D mixes, blends, homogenizes, disperses, and compounds the feedstocks 305 as said feedstocks 305 are moved down the barrel 310C. The screw(s) 310D of the at least two extruders 310 in the preferred embodiment comprises a plurality of zones, which act on the feedstocks 305/extrudate 320 in combination with the interior surface of the barrel 310C. In a preferred embodiment, the screws 310D comprise a feeder zone 311, compression zone, and metering zone 313. Some embodiments of the screws 310D may also comprise a degassing zone that coincides with a vent of the barrel 310C to allow for the off gassing of the extrudates 320.

The feeder zone 311 is located at the throat 310E of the barrels 310C and is deep enough to take in the feedstocks 305 injected into the barrels 310C. The action of the screws 310D moves the feedstocks 305 from the feeder zone 311 to the compression zone 312 where the distance between the interior surface of the barrel 310C and the screw 310D gradually reduces in such a way to build pressure and cause friction, which causes the binder material 305C to melt due to the increased temperature of the feedstocks 305. By melting the feedstocks 305, gasses that are created by a blowing agent can dissolve into the resulting extrudate 320 as well. In addition, the constant motion of the screw(s) 310D mixes hemp feedstocks 305 and melted binder material 305C to create at least two homogonous extrudates. The action of the screw(s) 310D moves these homogonous extrudates further down their respective barrels 310C into the metering zone 313 until all (or nearly all) of the feedstocks 305 are melted and mixed. The extrudates 320 are then pushed out of their respective barrels 310C through the openings of the barrels 310C at the end of the metering zone 313, allowing the manifold 325 to distribute and mold the extrudates 320 into a coextruded extrudate sheet 330. Temperature control of the extrudates 320 within the barrel 310C can be altered by the manipulation of several variables including, but not limited to, screw speed, screw shape, feedstock injection rate, die opening size, and difference in process gains for heating and cooling. For example, when using a single screw extruder comprising a tapered screw, an increase in screw speed increases shear within the barrel 310C, resulting in higher temperatures of the feedstocks 305/extrudate 320.

Because feedstock material pushed to the center of the screw channel of a three-zone screw within a single screw extruder can largely remain undisturbed, poor melt mixing can occur. This can result in inhomogeneous output due to non-uniform shear within the barrel 310C. Even in situations where mixing is not required due to use of a mixer 307 prior to injection into the extruder 310, temperature of the extrudate 320 within the barrel 310C of a single screw extruder will be non-uniform, which can cause alterations in output due to viscosity variations as well as distortion as the extrudate 320 cools during post-processing. This can be particularly problematic for thermoplastic binders since a slight variation in the melt temperature will have a very large effect on the viscosity of the total feedstock blends. If the melt viscosity of the feedstocks 305 closer to the center of the screw 310D is too low, agglomerates can escape the mixing action. Furthermore, differences in temperature of the extrudate can result in different amounts of dissolved gas, which can create pockets of non-uniform density throughout a foamed layer of the coextruded extrudate sheet 330. Improved dispersive mixing is obtained if the melt temperature can be kept low and uniform. A lower melt temperature should also reduce thermal damage to any hemp feedstocks contained within the melted binder material 305C regardless of any treatments/alterations the hemp feedstocks underwent prior to injection into the extruders 310. Barrel cooling may be used in regions where shear heat within the barrel 310C is higher due to dispersive mixing to create a more uniform melt and reduce damage to the hemp feedstocks.

In a preferred embodiment, the screw 310D of a single screw extruder should comprise both dispersive mixing sections and distributive mixing sections to improve melt mixing of the hemp feedstock and binder material 305C. These dispersive mixing sections and distributive mixing sections may be repeated multiple times to increase their effectiveness. Types of dispersive mixing sections that may be used include, but are not limited, shear/blister rings, fluted mixers, cross barrier mixers, and planetary-gear extruder mixers. In a preferred embodiment, a planetary-gear extruder mixer is used due to both good heat transfer properties, distributive mixing properties, and dispersive mixing properties. Types of distributive mixing sections that may be used include, but are not limited to, slotted flight mixers, pin mixers, cavity mixers, and variable depth mixers.

In a preferred embodiment, a twin screw extruder generally comprises two screws 310D having intermeshed or partially intermeshed screw channels that are configured to co-rotate within the barrel 310C. Like the single screw extruders, the action of the screws 310D in a twin-screw extruder mixes, blends, homogenizes, disperses, and compounds the feedstocks 305 as said feedstocks 305 are moved down the barrel 310C. Mixing elements of the screws 310D may be used in increase distributive and dispersive mixing within the barrel 310C. These mixing elements may include, but are not limited to reversed screw flights, kneading discs, pins, or any combination thereof. Because the twin screws constantly clean each other's screw channels, superior melt mixing can be achieved compared to single screw extruders. In some embodiments, a twin extruder may be used between a single screw extruder and a manifold 325, which can result in more consistent manifold output due to more consistent pressure. The shear rates possible within a twin screw extruder can be much larger than those possible within a single screw extruder, and the output of twin screw extruders is largely dependent on pressure within the manifold 325. This higher pressure within the manifold 325 can result in a broader range of material residence times, leading to the degradation of the hemp feedstock. Furthermore, the twin grinding action of the screws 310D can result in the destruction of longer feedstocks into shorter feedstocks. As a result, the use of twin screw extruders may be best for creating layers of finished CHB product 625 requiring hemp feedstocks that are shorter in length.

In some embodiments, a breaker plate and screens may be used at the manifold 325 end of the barrel 310C to create back pressure and improve mixing at the dispersive and distributive mixing sections. However, the use of a breaker plate and screens should be limited to applications in which the hemp feedstocks used are of a very small length/diameter to decrease the likelihood that the screen becomes clogged and prevents the flow of extrudates 320 to the manifold 325. In some preferred embodiments of an upstream extruding arrangement, a twin screw extruder may be used to connect a single screw extruder to a manifold 325. In such an embodiment, the twin screw extruder may make the extruder 310 connected to it independent of back pressure, eliminating the need for breaker plates and screens. In a preferred embodiment, a gear pump extruder comprising two counter rotating, interlocking gears may be used to connect a single screw extruder to the manifold 325.

The manifold 325 is configured to accept the at least two extrudates 320 from the barrel 310C of the extruder 310 via an entry channel and distribute said extrudates 320 across a width of a die outlet. The extrudates 320 are accepted by the manifold 325 from the entry channels of the at least two extruders 310 via inlet ports. The die outlet of the manifold 325 molds the at least two extrudates 320 produced by the extruders 310 into a coextruded extrudate sheet 330 having a desired shape, wherein said desired shape may or may not require further processing via a choker bar, lower lip, flex-lip, and/or machinery of a downstream extrusion arrangement 115 to acquire a finished CHB product 625. In a preferred embodiment, coextrusion feed block manifolds and multimanifolds may be used to create the coextruded extrudate sheet 330 that is to be shaped into coextruded hemp-based construction boards, wherein a slit manifold is used to create the coextruded extrudate sheet 330 that is to be shaped into a finished CHB product 625.

The slit manifold may have symmetrical or asymmetrical die outlet. The symmetrical die outlet provides a superior flow distribution compared to that of an asymmetrical die outlet due to the features of the two halves of the die outlet being identical, which results in fewer potential defects in the coextruded extrudate sheet 330 once it has cooled; however, an asymmetrical die outlet may incorporate features into the coextruded extrudate sheet 330 prior to post-extrusion processing, resulting in a lower cost of production for finished CHB products 625 possessing enhanced features such as “tongue and groove,” slots, depressions, linear scoring, ridges, waves, thicker or thinner sections, angles, profiles, etc. For example, the manifold 325 may be configured to mold finished CHB product 625 into the shape of furniture components, which can replace plywood. The finished CHB product 625 furniture components should be cheaper to produce and be capable of producing flexible shapes and sizes and should require less processing, resulting in less waste than wood-based components.

In some preferred embodiments, the method the present disclosure may be used to produce ordered components that may be used to create an entire structure. These ordered components are preferably configured to fit together in a very specific manner, and may comprise finished CHB products 625 including, but not limited to, boards, beams, wallboard, roof boards, etc. In a preferred embodiment, the structure create by these ordered components is a residential home. For example, ordered components may be configured to fit together in a way such that a mobile home may be constructed, which may result in more affordable and environmentally friendly mobile homes that what is currently available. Due to the nature of extrusion and the materials used to create finished CHB products 625, ordered components may be specifically created for inexpensive, easy to assemble emergency shelters when compared to emergency shelters created using traditional construction materials. For example, ordered components may be configured to fit together in a way such that an emergency barracks may be constructed quickly in a natural disaster zone, which may provide temporary shelter for those left homeless by a disaster.

In another preferred embodiment, the die outlet may be configured to create patterns 905 as the extrudate 320 is ejected from the die outlet to form the coextruded extrudate sheet 330. For example, as illustrated in FIG. 9, the die may be configured to output a coextruded extrudate sheet 330 comprising a plurality of micronized grooves on at least one of the surfaces, wherein the microgrooves increase adhesion of a finishing coating or adhesive, such as laminates, paper, films, paint, tar, wax, glue, or any combination thereof. In other embodiments, a router may be used to create channels within the coextruded extrudate sheet 330. Patterns 905 that may be implemented into the coextruded extrudate sheet 330 via the die include, but are not limited to, micronized grooves, popcorn, orange peel, knockdown, sand swirl, slap brush, and comb.

The die may also be configured to produce a coextruded extrudate sheet 330 comprising at least one molded shape. In one preferred embodiment, the at least one molded shape is located on one or more edges of the coextruded extrudate sheet 330. For example, as illustrated in FIG. 10, a coextruded extrudate sheet 330 optimized for wallboard may comprise an architectural molding on one edge and a flat surface on the other edge, wherein the architectural molding formed by the die as the extrudate 320 is extruded to form the coextruded extrudate sheet 330. Molded shapes that may be implemented into the coextruded extrudate sheet 330 via the die include, but are not limited to, base architectural molding, crown architectural molding, and corner architectural molding.

In some preferred embodiments, the die outlet may be optimized to produce a finished CHB product 625 optimized for decking and/or fencing applications. Finished CHB products 625 optimized for such applications may be expected to perform exceptionally well due to a higher water/pest resistance as well as due to a more consistent grain resulting from the dispersive and disruptive mixing that occurs during extrusion. Dies configured to produce common sizes are optimal for producing decking and fencing. For example, a finished CHB product 625 optimized for decking and/or fencing may be output from the die and/or shaped into any traditional size, including, but not limited to, 2″×4″, 2″×6″, 2″×8″, 1″×4″, 1″×6″, and 1″×4″. In one preferred embodiment, a finished CHB product 625 optimized for decking and/or fencing may be “scored” in order to allow for a complete sheet of boards to be shipped to an installation site, where the boards may then be snapped apart with minimal effort prior to installation. In a preferred embodiment, finished CHB products 625 optimized for decking and fencing utilizes a tongue and groove system to create true privacy fences that are interconnected without the need for an abundance of fasteners. This system may also be used to create a “solid deck” having minimal or no gapping between the boards.

Once the extrudate 320 has been pushed through the die outlet to form the coextruded extrudate sheet 330, the coextruded extrudate sheet 330 may be further shaped and gradually cooled by the downstream extrusion arrangement. As previously mentioned, one of the advantages of the extrusion production process for creating a finished CHB product 625 is that it may be used to produce a number of different patterns, textures, and designs that provide functional benefits in addition to aesthetic value. For example, a finished CHB product 625 optimized for decking may comprise channels that run the length of the board. By changing the overall surface area of the finished CHB product 625 with high, then low channels, a heat sink effect is produced, which increases the amount of heat dissipated by the board. These channels may also be configured to serve as a gutter to move water away from the home when properly installed. In some preferred embodiments, a finished CHB product 625 optimized for decking may comprise a pattern 905 that includes a raised height with a dimpled surface that reduces contact with human feet and other body parts. Additionally, a dimpled surface, as illustrated in FIG. 11, will dissipate radiational heat by increasing the overall surface area of the board as well as increase friction that reduces the likelihood of slipping when walking on said board.

Finished CHB products 625 optimized for decking board and fencing board applications are preferably made from post-consumer/post-industrial recycled thermoplastics and thermoplastics, or a blend of other highly loaded recycled materials plus small amounts of virgin material to increase flow rates. Hemp feedstocks preferably range from 15% to 70% by volume of the extrudate 320, depending on the target application and board thickness. For example, in cold climates, thermoplastics will become more brittle as the temperature approaches freezing (and falls below freezing), so a board comprising a higher amount of hemp feedstock may be more desirable. By increasing the impact strength through either a reduction in the total hemp loading or by increasing the amount of the impact modifier, or both, an extruded board can be created that can handle cold temperature environments with greater impact resistance. Selection of the thermoplastic binder will affect the CHB's performance in cold temperatures based on the application in addition to the above. Additionally, woven materials may be incorporated into a finished CHB product 300 as a substrate layer as a way of increasing the impact strength of the finished CHB product 300. For instance, a plurality of fiberglass mesh screen substrates (woven roving) may be incorporated into the finished CHB product 300 to not only increase the impact factor of the finished CHB product 300 but also increase the board's resistance to pests. Additionally, hemp fiber, in a woven fabric or non-woven format may be used in the same fashion, as well as a hemp fiber and fiberglass combination, or hemp fiber and aramid fiber combination, or any blend of the sort to achieve differing levels of performance.

In a preferred embodiment, hemp and/or aramid fiber layers, or blends, would be extruded into the CHB to increase strength of tensile properties, and increase penetration properties when deployed in difficult military or law enforcement environments. When combined with UHMWPE (ultra-Ultra High Molecular Weight Polyethylene) in multiple layers and at a specified thickness to achieve the strictest NIJ levels of performance, these CHB boards would provide significant projectile protection as well as ancillary shrapnel from an intentional or unintentional explosion and potentially saving human disfigurement and human lives. These CHB composite boards would be beneficial for use in military, military housing, law enforcement posts, government buildings both domestic and foreign, and even in private citizen homes.

Further, finished CHB products 625 optimized for decking and/or fencing possess natural UV resistance due to the hemp feedstocks dispersed throughout. This UV resistance in combination with the water resistance, resulting from the encapsulation of said hemp feedstocks in a hydrophobic binder material, will create a natural barrier to UV degradation and water resistance for years of service life beyond that of traditional wood decking. In some embodiments, the incorporation of metal nanoparticles or other compounds/elements, such as chromated copper arsenate and zinc, may be used to provide resistance to fungal growth and pests. Additionally, finished CHB products 625 optimized for fencing and decking do not experience the same accelerated degradation that occurs in traditional wood decking/fencing when fasteners used to secure the decking/fencing to a framework create holes that form intrusion points for water and pests, and which increase in size as the boards experience freeze and thaw cycles in cold and temperate climates. The resistance to decay around the holes created by fasteners shown by finished CHB products 625 optimized for fencing and decking is due to the composition of the extrudate and the inherent water, fungal, and pest resistance of the finished CHB product 625.

In some preferred embodiments, a feed block manifold is used to create the coextruded extrudate sheet 330 where differences in viscosities of the at least two extrudates 320 may be taken advantage of. In a feed block manifold, lower viscosity extrudates may be encapsulated by the higher viscosity extrudates. As such, a higher viscosity extrudate may be designed to comprise a larger volume percentage of hemp feedstock since it can be encapsulated by a lower viscosity extrudate possessing hydrophobic properties. In one preferred embodiment, the higher viscosity extrudate is also blown, resulting in a coextruded polymer having a foamed core. However, in embodiments where encapsulation is not needed and/or desired, a multimanifold is preferably used due to superior flow patterns within the manifold 325, which may result in fewer defective areas within the final coextruded hemp-based wallboard product.

In other preferred embodiments, the upstream extrusion arrangement 110 may be configured to coextrude one or more extrudates 320 onto a substrate. The substrate preferably comprises a sheet consisting of one or more layers of material. For example, a substrate may comprise a polymer layer having chain link incorporated onto the top and bottom surfaces. The substrate may be moved to the upstream extrusion arrangement 110 by a plurality of rollers 505, wherein at least one manifold 325 of the upstream extrusion arrangement 110 may be configured to extrude one or more extrudates 320 thereon. For example, an upstream extrusion arrangement 110 comprising two manifolds 325 may create a coextruded extrudate sheet 330 by extruding a first extrudate on a top surface of the substrate and a second extrudate on a second surface of said substrate. The resulting coextruded extrudate sheet 330 may then undergo post-extrusion processing, as illustrated in FIG. 5, via the downstream extrusion arrangement 115 to produce a finished CHB product 625.

In one preferred embodiment, the method of creating CHB may be used to create coextruded hemp duct board (CHDB) 1605 and/or duct liner, which may be used for commercial and residential HVAC ducting and other air movement applications. CHDB 1605 may be configured to contain all the properties necessary in most ducting applications including, but not limited to, air sealing, insulative, sound deadening, vapor barrier, strength to weight ratio, antimicrobial and mold resistance, and fire resistance. Additionally, by using a flexible, substrate layer in combination with one or more mixed extrudate layers that are coextruded onto said flexible, substrate layer, a rigid but versatile duct board may be created for just about any HVAC application. In addition, the downstream extrusion arrangement may be used to treat the duct board with flame retardants, antimicrobial agents, etc. and/or apply an additional substrate layer to increase the performance of the coextruded duct board product. For instance, a first layer 1605A comprising a fabric mat substrate and a second coextruded layer comprising water-resistant binder and hemp feedstock may be painted and have a vapor barrier layer applied thereto by the downstream extrusion arrangement.

In one preferred embodiment, the methods described herein may be used to create a CHDB 1605 having multiple co-extruded layers based on the desired properties of the application in which the CHDB 1605 will be used. Layers that may be used to create the CHDB 1605 include, but are not limited to insulative layers, sound-deadening layers, antimicrobial layers, and laminar flow layers. Foamed coextruded layers may be used to provide insulative and sound-deadening properties as well as provide additional rigidity. Layers including secondary feedstocks could be used to provide some of the properties listed above, such as fire resistance and antistatic properties. In a preferred embodiment, the side of the finished EHB product that is meant to serve as the interior surface layer of ductwork made of CHDB 1605 may be an extruded layer of thermoplastic, thermoset, veil, or natural binder that may or may not include hemp feedstocks. In other preferred embodiments, this interior surface layer may also be loaded with secondary feedstocks, including, but not limited to, carbon black, to add antimicrobial and fire-retardant properties and/or to color the CHDB 1605. For instance, Zinc Omadine may be used as a secondary feedstock within the interior surface layer to prevent bacteria and mold growth in addition to bestowing fire-retardant properties to the interior surface. In other preferred embodiments, an outer surface layer of the CHDB 1605 may comprise a coextruded water-resistant layer. In yet another preferred embodiment, a vapor barrier layer, such as a reflective metallic film, may be incorporated into the board either as part of a substrate or by the downstream extrusion arrangement during post extrusion processing.

In a preferred embodiment, a substrate is used to create CHDB 1605. For instance, a fibrous glass mat may act as a first layer 1605A and substrate on which a second foamed layer may adhere, wherein said second foamed layer comprises 10% by volume hemp feedstock, 5% by volume recycled glass, and 85% by volume post-consumer plastic. The resulting coextruded extrudate sheet having two layers may then act as a substrate on which a third fire-resistant layer may adhere, wherein said third fire-resistant layer comprises 30% by volume hemp feedstock, 7% by volume red phosphorus, 8% by volume black carbon, and 55% by volume post-consumer plastic. The resulting co-extruded extrudate sheet having a first layer 1605A, second layer 1605B, and third layer 1605C may then be used as a finished product once processed by the downstream extrusion arrangement. In another embodiment, the resulting co-extruded extrudate sheet having three layers may be used as a substrate to create a duct board having four or more layers. In another preferred embodiment, CHDB 1605 may include a substrate layer of hemp feedstocks in the form of a woven fabric, or non-woven material as a structural layer in combination with a polymer or natural binder. This layer may be coextruded within the polymer matrix to provide increased flexural modulus and puncture strength.

In a preferred embodiment, the CHDB 1605 may be “scored” in way that allows for consistent and quick construction of ductwork by users using the CHDB 1605. For instance, a single 8′×8′ sheet of CHDB 1605 comprising scores every 3″ may be used to construct up to 8′ of length a ductwork system that starts as 2′×2′×2′ and tapers every 24′ down to 1′×6″, resulting in minimal waste and precise measurements/cuts. In other preferred embodiments, the CHDB 1605 may comprise a “score and ball” pattern 1607, as illustrated in FIGS. 16 and 17. Hook ends 1606 of CHDB 1605 comprising a “score and ball” pattern 1607 may be shaped in a way that accommodates the “ball” end of the CHDB 1605, allowing for the CHDB 1605 to rotate therein. By adjusting the size of the opening of the hook end 1606 of the CHDB 1605 and the length of each CHDB 1605, a user may vary the ultimate shape of ductwork created by CHDB 1605 comprising a “score and ball” pattern 1607. In a preferred embodiment, the final shape of ductwork created using CHDB 1605 is square, but other shapes of ductwork, including, but not limited to, triangles, pentagons, hexagons, heptagons, and octagons, may be created from CHDB 1605 comprising a “score and ball” pattern 1607 without departing form the inventive subject matter described herein. The downstream extrusion arrangement is preferably used to create the “score and ball” pattern 1607 and/or the hook ends 1606. In a preferred embodiment, the “score and ball” pattern 1607 and/or the hook end 1606 features may be incorporated into the final CHDB 1605 via methods including, but not limited to, planing, cutting, milling, routing, or any combination thereof.

In some preferred embodiments, the system 100 may comprise more than one upstream extrusion arrangement 110 and downstream extrusion arrangement 115. For example, a first upstream extrusion arrangement 110 may be configured to produce a monolayered extrudate sheet that is processed by a first downstream extrusion arrangement 115 to add a texture to the surface of said monolayered extrudate sheet to increase surface area. This textured, monolayered extrudate sheet may then be used as a substrate by a second upstream extrusion arrangement 110 to create a coextruded extrudate sheet 330, which may be processed by a second downstream extrusion arrangement 115. The increased surface area of the substrate (due to the texture) may increase binding between the layers adhered directly to the substrate. In some preferred embodiments, the first downstream extrusion arrangement 115 may be configured to treat the surfaces of the resulting substrate of the first upstream extrusion arrangement 110 so that extrudates 320 of the second upstream extrusion arrangement 110 may more strongly bind thereto. In other preferred embodiments, the first downstream extrusion arrangement 115 may be configured to coat the resulting substrate of the first upstream extrusion arrangement 110 with coating materials, including, but not limited to, binders, sealants, fire retardants, insecticides, fungicides, or any combination thereof prior to being transformed into a coextruded extrudate sheet 330 by the second upstream extrusion arrangement 110.

The temperature of the manifold 325 is preferably controlled so that it is the same temperature as the extrudates 320 to reduce temperature differences (and therefore viscosity differences) in the extrudates 320 as the extrudates 320 make their way to die outlet. Temperature differences could result in differences in flow distribution across the manifold 325 and cause the extrudates 320 to coalesce into defects within the finished CHB product 625, so it is important to keep the temperature of the extrudates 320 as consistent as possible within the manifold 325 where similar viscosities are needed. In some embodiments, the manifold 325 may comprise multiple heaters so that heat zones may be used to control flow of the extrudates 320 through the die. Types of heaters that may be used to heat the manifold 325 include, but are not limited to, plate heaters, cast heaters, and cartridge heaters. In a preferred embodiment, an electric heater is used to control the temperature of the walls of the manifold 325. In some preferred embodiments, the temperature of the walls of the manifold 325 may be higher than that of the extrudates 320 to create a glossy finish on the coextruded extrudate sheet 330.

Due to shear forces acting on extrudates 320 due to the extrusion process, a resulting finished CHB product 625 product may be somewhat anisotropic in its behavior. However, as previously mentioned, the addition of hemp feedstocks to the binder material 305C can improve the properties of the finished CHB product 625 by increasing the binding between the layers of binder fibers/chains. Though the same shear forces acting on the hemp feedstocks can cause said hemp feedstocks to align in the same general direction as the binder material 305C, hemp feedstocks can also strongly bond with the binder material 305C in which it is encapsulated, resulting in a strong hemp-binder matrix. Blends of hemp feedstocks of varying sizes can impart benefits that feedstocks 305 having a smaller size range might not produce due to a wider variety of bonding with a broader size range. For example, where blends of the hemp fiber 305B and hemp hurd 305A contain variable lengths (potentially not discernible to the human eye, but as measured in microns), micronized hemp fiber 305B and micronized hemp hurd 305A will fill in voids (voids being defined as areas where there is significantly more binder material than hemp material as observed under a microscope) and create a hemp composite material with increased strength and fewer defective areas due to more structure thanks to the more consistent hemp-binder matrix.

Additionally, the binding of the binder material to the micronized hemp feedstocks will negate the effect of any orientation of the hemp in the extrusion process. And orientation of dispersed/distributed hemp fiber 305B and/or hemp hurd 305A of various lengths within the finished CHB product 625 will also create benefits when the output direction versus transverse direction of the final product is considered since it will result in a final product with increased flexural modulus, increased tensile strength, and natural UV inhibition. Further, when the binder material 305C used to make the finished CHB product 625 is that of a thermoplastic binder, encapsulation of the hemp fiber 305B and hemp hurd 305A within the thermoplastic binder provides increased water resistance. Thus, resulting in a composite board that is especially superior in situations where there is high risk of water exposure. As such, extruded finished CHB product 625 is a cost effective, viable alternative for roof boards, decking, subfloors, and interior and exterior wallboards due to its water-resistant properties.

Once the coextruded extrudate sheet 330 has been pushed through the die, it is shaped and gradually cooled by the downstream extrusion arrangement 115. In a preferred embodiment, the downstream extrusion arrangement 115 comprises a plurality of rollers 505, heaters/coolers 510 (chemical, mechanical, gas, water, etc.), cutter 515, molder 520, sander 525, painter 530, and stacker. Initial sizing past the die may be accomplished via the plurality of rollers 505 that compress/pull the coextruded extrudate sheet 330 to the desired thickness and/or corrugate the coextruded extrudate sheet 330 with a desired texture. A series of polishing rolls may be used to achieve finished CHB product 625 having a good surface finish with minimal defects for finished CHB product 625. In some embodiments, heated rollers may be used to keep the temperature such that the coextruded extrudate sheet 330 is still pliable to allow for further sizing (via the molder), compression (for the removal of air), and compaction of the coextruded extrudate sheet 330. A plurality of water-cooled rollers may be used to cool the coextruded extrudate sheet 330 once it has been shaped or as it leaves the manifold 325. In another preferred embodiment, a series of polishing rollers may be used to achieve a finished CHB product 625 that has a surface finish with low variability, which may allow for a more consistent application of a secondary finish or coating, such as paint and tar.

In a preferred embodiment, the coextruded extrudate sheet 330 is pressed in line and under heat at the binder softening temperature so that compression and/or shaping of the coextruded extrudate sheet 330 may occur. Rollers and/or a post-curing processing methods may then be used to form patterns 905 on one or more surfaces of the coextruded extrudate sheet 330 while it is still pliable. In some embodiments, patterns 905 created by rollers and/or a post-curing processing methods may be implemented on the surfaces in addition to patterns 905 created by the die. For instance, the die may be configured to create a coextruded extrudate sheet 330 having a knockdown pattern 905 on one or more surfaces of the coextruded extrudate sheet 330 whereas the rollers may be configured to add a plurality of micronized grooves to one or more surfaces of the coextruded extrudate sheet 330. Patterns 905 that may be implemented into the coextruded extrudate sheet 330 via the rollers and/or post-curing processing methods include, but are not limited to, micronized grooves, popcorn, orange peel, knockdown, sand swirl, slap brush, and comb.

Rollers and/or a post-curing processing methods of the downstream extrusion arrangement may also be configured to produce a coextruded extrudate sheet 330 comprising at least one molded shape. Molded shapes may be formed by the rollers and/or post-curing processing methods either with the output direction of the die or perpendicular with the output direction of the die. For instance, as illustrated in FIG. 10, a coextruded extrudate sheet 330 may be shaped by the rollers into a single piece having a plurality of architectural molding shapes in a single piece and perpendicular to the output direction of the die. Molded shapes that may be implemented into the coextruded extrudate sheet 330 via the die include, but are not limited to, base architectural molding, crown architectural molding, and corner architectural molding.

Where the coextruded extrudate sheet 330 has cooled beyond a “pliable or malleable state”, further processing may be accomplished by several finishing processes, including, but not limited to, rollers, planing, sanding, cutting, routing, scoring or any combination thereof. A planer and/or sander may be used to size the coextruded extrudate sheet 330 to its final thickness, width, and/or length. Additionally, the use of a planer, sander, router, etc. may be used to remove material from the coextruded extrudate sheet 330 to form patterns 905. For instance, a CNC router may be used to create geometric patterns on one or more surfaces of the coextruded extrudate sheet 330. In embodiments comprising a coextruded extrudate sheet 330 having layers of multiple colors, planing, sanding, cutting, routing, and scoring may be used to create unique pattern/color combinations that is not achievable in traditional construction boards.

The use of a planer, sander, router, etc. may also be used to transform the sides of the coextruded extrudate sheet 330 into interlocking edges. As illustrated in FIG. 6, the finished CHB product 625 may comprise a first edge and second edge configured to interlock with one another. In a preferred embodiment, a plurality of finished CHB boards may be fitted together using locking edges, wherein a first edge of a first finished CHB boards is configured to interlock with a second edge of a second finished CHB boards. The plurality of edges of the finished CHB boards is preferably “tongue and groove” style, which allows for the first finished CHB boards to interlock with the second finished CHB boards. In another preferred embodiment, the locking edges of the finished CHB boards may be comprise a notch and groove style edge as depicted in FIG. 6, which may allow for easier installation when compared to other locking edge styles. In other embodiments, the post-curing processing methods (planing, sanding, routing, etc.) may be used to create channels within the coextruded extrudate sheet 330. The channels are preferably located on the bottom surface of the coextruded extrudate sheet 330 and sized in a way such that electrical hardware, plumbing, and radiant heating may installed in the channels.

In one preferred embodiment, an inline cutting device may be used to cut the coextruded extrudate sheet 330 to the desired length. The inline cutting device may also be used to cut more intricate shapes into the coextruded extrudate sheet 330, such as slots, holes, custom angles, edges, and fastener points. In a preferred embodiment, the inline cutting device comprises at least one of reciprocal blades, wheels, knives, laser, water, or CNC type cutting. For right-angled smooth cuts, it is essential to select the correct saw speed and blade for the polymer used and the thickness of the coextruded extrudate sheet 330. After cutting, the resulting finished CHB product 625 is lifted by a stacker and stacked. Alternatively, the stacker may move the finished CHB product 625 to a conveyor where it may be at least one of primed, painted, chemically treated, corona treated, edge coated, laser etched, laminated, tarred or any combination thereof.

Due to the to the use of recycled materials and sustainable hemp feedstocks, the various finished CHB products 625 created using the methods described herein will result in a tremendous benefit to the environment when evaluated through a life cycle analysis (LCA). Finished CHB products 625 under LCA will show that by using sustainable hemp feedstocks, reclaimed “waste” materials from construction and manufacturing processes, reduced shipping weights, and streamlined processing will dramatically offset the carbon offenses in the construction industry, and provide permanent carbon sequestration opportunities that currently do not exist today in available solutions. Additionally, the methods described herein include the possibility of including carbonized materials into the final product by using it as a feedstock, allowing for high carbon sequestration crops, such as hemp and/or bamboo, to be grown and turned into bio-carbon via pyrolysis before incorporation into the process described herein as a feedstock and carbon sink. This is possible because of the unique way that finished CHB products 625 are produced using the method described herein. As such, when compared with the traditional methods or production for traditional construction materials, the LCA will show that the finished CHB products 625 produced by the methods described herein are not only superior in terms of carbon capture but are also more sustainable.

Although the systems and processes of the present disclosure have been discussed for use within the construction material field, one of skill in the art will appreciate that the inventive subject matter disclosed herein may be utilized in other fields or for other applications in which hemp-based composites are needed. The implementations set forth in the foregoing description do not represent all implementations consistent with the subject matter described herein. Instead, they are merely some examples consistent with aspects related to the described subject matter. Although a few variations have been described in detail above, other modifications or additions are possible. Further features and/or variations can be provided in addition to those set forth herein. For example, the implementations described above can be directed to various combinations and sub-combinations of the disclosed features and/or combinations and sub-combinations of several further features disclosed above. In addition, the logic flow depicted in the accompanying figures and/or described herein do not necessarily require the particular order shown, or sequential order, to achieve desirable results. It will be readily understood to those skilled in the art that various other changes in the details, materials, and arrangements of the parts and process stages which have been described and illustrated to explain the nature of this inventive subject matter can be made without departing from the principles and scope of the inventive subject matter.

What is claimed is:

1. A method for making a coextruded hemp composite board (CHB) comprising steps of:
obtaining hemp feedstock comprising at least one of hemp hurd and hemp fiber,
obtaining a binder material comprising at least one of polyolefin, polyethylene, polyamide, and polypropylene,
obtaining an CHB extruding system comprising an extruder, puller, and plurality of rollers,
injecting said hemp hurd, hemp fiber, and binder material into said extruder,
wherein said extruder creates an extrudate using said hemp feedstock and binder material,
wherein a heated barrel of said extruder keeps said extrudate within a desired temperature range,
wherein said desired temperature range is higher than a melting point of said binder material and lower than a combustion point of said hemp hurd and said hemp fiber,
controlling a shear force of said extruder in order to manipulate a viscosity of said extrudate,
wherein said extrudate is expelled from extruder via a die outlet of a manifold at a rate relative to said viscosity,
wherein said die outlet forms said extrudate into an extrudate sheet,
pulling said extrudate sheet from said extruder via a puller,
wherein said puller removes said extrudate sheet from said die outlet at a desired speed,
wherein said desired speed is used to control a thickness of said extrudate sheet, and
molding said extrudate sheet into shaped CHB using said plurality of rollers,
wherein said plurality of rollers alter at least one of an CHB thickness and CHB width,
wherein said extrudate sheet is heated as said plurality of rollers alter at least one of said CHB thickness and said CHB width.

2. The method of claim 1, wherein said extruder is one of a single screw extruder and a twin screw extruder.

3. The method of claim 1, wherein said hemp fiber has been processed to remove pectins and lignins.

4. The method of claim 1, wherein said hemp feedstock comprises both hemp hurd and hemp fiber, wherein a volume of said hemp hurd of said hemp feedstock is approximately three times greater than a weight of said hemp fiber.

5. The method of claim 1, wherein a combined volume percentage of said hemp hurd and said hemp fiber makes up at least 8% of a total volume percentage of said hemp hurd, hemp fiber, and binder material transferred to said extruder.

6. The method of claim 5, further comprising additional steps of:
obtaining a blowing agent configured to foam said extrudate,
wherein gasses of said blowing agent dissolve into said extrudate to create a foamed extrudate sheet, and
injecting said blowing agent into said extruder in order to create said foamed extrudate sheet.

7. The method of claim 5, further comprising additional steps of:
obtaining bio-derived carbon,
wherein said bio-derived carbon is obtained via a pyrolysis process, and
injecting said bio-derived carbon into said extruder with said hemp hurd, hemp fiber, and binding agent.

8. The method of claim 5, further comprising additional steps of:
obtaining at least one of glass fiber, wood fines, and gypsum, and
injecting at least one of said glass fiber, wood fines, and gypsum into said extruder with said hemp hurd, hemp fiber, and binding agent.

9. The method of claim 1, wherein at least one of said hemp fiber and hemp hurd are chemically treated or coated to increase resistance to degradation of said hemp hurd and said hemp fiber, wherein at least one of said hemp fiber and said hemp hurd are chemically treated or coated to increase a flow of said hemp fiber and hemp hurd.

10. A method for making a coextruded hemp composite board (CHB) comprising steps of:
obtaining a hemp feedstock comprising at least one of hemp hurd and hemp fiber,
obtaining a binder material comprising at least one of polyolefin, polyethylene, polyamide, and polypropylene,
obtaining an CHB extruding system comprising an upstream extrusion arrangement and a downstream extrusion arrangement,
transferring said hemp feedstock and said binder material to said upstream extrusion arrangement,
wherein said hemp feedstock and said binder material are transferred to an extruder of said upstream extrusion arrangement via a throat of said extruder,
wherein said hemp feedstock makes up at least 8% of a total volume percentage of said hemp feedstock and said binder material transferred to said extruder,
wherein said extruder creates an extrudate using said hemp feedstock and said binder material,
wherein a heated barrel of said extruder keeps said extrudate within a desired temperature range,
wherein said desired temperature range is higher than a melting point of said binder material and lower than a combustion point of said hemp feedstock,
wherein said extrudate is expelled from extruder via a die outlet of a manifold at a rate relative to a viscosity of said extrudate,
wherein said die outlet forms said extrudate into an extrudate sheet,
controlling a shear force of said extruder in order to manipulate said viscosity of said extrudate,
pulling said extrudate sheet from said extruder via a puller,
wherein said puller removes said extrudate sheet from said die outlet at a desired speed,
wherein said desired speed is used to control a thickness of said extrudate sheet, and
molding said extrudate sheet into shaped CHB using a plurality of rollers,
wherein said plurality of rollers alter at least one of an CHB thickness and CHB width,
wherein said extrudate sheet is heated as said plurality of rollers alter at least one of said CHB thickness and said CHB width.

11. The method of claim 10, wherein said extruder is one of a single screw extruder and a twin screw extruder.

12. The method of claim 10, wherein said hemp fiber has been processed to remove pectins and lignins.

13. The method of claim 10, further comprising additional steps of:
obtaining a blowing agent configured to foam said extrudate,
wherein gasses of said blowing agent dissolve into said extrudate to create a foamed extrudate sheet, and
injecting said blowing agent into said extruder in order to create said foamed extrudate sheet.

14. The method of claim 10, further comprising additional steps of:
obtaining bio-derived carbon,
wherein said bio-derived carbon was obtained via a pyrolysis process, and
injecting said bio-derived carbon into said extruder with said hemp hurd, hemp fiber, and binding agent.

15. The method of claim 10, further comprising additional steps of:
obtaining at least one of glass fiber, wood fines, and gypsum, and
injecting at least one of said glass fiber, wood fines, and gypsum into said extruder with said hemp hurd, hemp fiber, and binding agent.

16. The method of claim 10, wherein at least one of said hemp fiber and hemp hurd are chemically treated or coated to increase resistance to degradation of said hemp hurd and said hemp fiber, wherein at least one of said hemp fiber and said hemp hurd are chemically treated or coated to increase a flow of said hemp fiber and hemp hurd.

17. A method for making a hemp composite board (CHB) comprising steps of:
obtaining hemp bales comprising compressed hemp biomass,
obtaining a binder material comprising at least one of polyolefin, polyethylene, polyamide, and polypropylene,
obtaining an CHB extruding system comprising a separation arrangement, upstream extrusion arrangement, and downstream extrusion arrangement,
processing said hemp bales into hemp hurd and hemp fiber using said separation arrangement,
wherein said separation arrangement comprises an opener and a cleaner,
wherein said opener decompresses said hemp bales into decompressed hemp biomass,
wherein said cleaner breaks said decompressed hemp biomass into said hemp hurd and said hemp fiber,
wherein said hemp hurd and said hemp fiber are mixed at a ratio of three to one by volume of said hemp hurd to said hemp fiber to create a hemp feedstock,
transferring said hemp feedstock and said binder material to said upstream extrusion arrangement,
wherein said hemp feedstock and said binder material are transferred to an extruder of said upstream extrusion arrangement via a throat of said extruder,
wherein said extruder is one of a single screw extruder and a twin screw extruder,
wherein said hemp feedstock makes up at least 8% of a total volume percentage and no more than 80% of said total volume percentage of said hemp feedstock and said binder material transferred to said extruder,
wherein said extruder creates an extrudate using said hemp feedstock and said binder material,
wherein a heated barrel of said extruder keeps said extrudate within a desired temperature range,
wherein said desired temperature range is higher than a melting point of said binder material and lower than a combustion point of said hemp feedstock,
wherein said extrudate is expelled from extruder via a die outlet of a manifold at a rate relative to a viscosity of said extrudate,
wherein said die outlet forms said extrudate into an extrudate sheet,
controlling a shear force of said extruder in order to manipulate said viscosity of said extrudate,
pulling said extrudate sheet from said extruder via a puller,
wherein said puller removes said extrudate sheet from said die outlet at a desired speed,
wherein said desired speed is used to control a thickness of said extrudate sheet, and
molding said extrudate sheet into shaped CHB using a plurality of rollers,
wherein said plurality of rollers alter at least one of an CHB thickness and CHB width,
wherein said extrudate sheet is heated as said plurality of rollers alter at least one of said CHB thickness and said CHB width.

18. The method of claim 17, further comprising additional steps of:
obtaining a blowing agent configured to foam said extrudate,
wherein gasses of said blowing agent dissolve into said extrudate to create a foamed extrudate sheet, and
injecting said blowing agent into said extruder in order to create said foamed extrudate sheet.

19. The method of claim 17, further comprising additional steps of:
obtaining bio-derived carbon,
wherein said bio-derived carbon was obtained via a pyrolysis process, and
injecting said bio-derived carbon into said extruder with said hemp hurd, hemp fiber, and binding agent.

20. The method of claim 17, further comprising additional steps of:
obtaining at least one of glass fiber, wood fines, and gypsum, and
injecting at least one of said glass fiber, wood fines, and gypsum into said extruder with said hemp hurd, hemp fiber, and binding agent.

21. A method for making a coextruded hemp duct board (CHDB) comprising steps of:
obtaining hemp feedstock comprising at least one of hemp hurd and hemp fiber,
obtaining a binder material comprising at least one of polyolefin, polyethylene, polyamide, and polypropylene,
obtaining a flexible, substrate layer having a first side that forms a first surface,
obtaining an CHB extruding system comprising an extruder, puller, and plurality of rollers,
injecting said hemp hurd, hemp fiber, and binder material into said extruder,
wherein said extruder creates an extrudate using said hemp feedstock and binder material,
wherein a heated barrel of said extruder keeps said extrudate within a desired temperature range,
wherein said desired temperature range is higher than a melting point of said binder material and lower than a combustion point of said hemp hurd and said hemp fiber,
controlling a shear force of said extruder in order to manipulate a viscosity of said extrudate,
wherein said extrudate is expelled from extruder via a die outlet of a manifold at a rate relative to said viscosity,
feeding said flexible, substrate layer to an upstream extrusion arrangement in a way such that said extrudate may be used to coat said first surface of said flexible, substrate layer, and
expelling said extrudate from said extruder and onto said first surface of said flexible, substrate layer to create a coextruded extrudate sheet,
wherein said flexible, substrate layer is fed to said upstream extrusion arrangement at a first desired speed and said extrudate is expelled from extruder at a second desired speed,
wherein said first desired speed and said second desired speed dictate a thickness of said extrudate on said first surface of said flexible, substrate layer,
wherein said coextruded extrudate sheet comprises said flexible, substrate layer and at least one extrudate layer.

22. The method of claim 21, wherein said flexible, substrate layer comprises at least one of glass, metal, polymer, or natural material.

23. The method of claim 21, further comprising the steps of:
molding said coextruded extrudate sheet into shaped CHDB using a downstream extrusion arrangement.

24. The method of claim 23, further comprising the steps of:
creating a first locking feature located on a first edge,
wherein a middle section between said first edge and a second edge connects said first edge and said second edge,
wherein a second locking feature is located on said second edge,
wherein said second locking feature of said second edge comprises a hook configured to hold a rounded edge feature.

25. The method of claim 23, further comprising the steps of:
creating a first locking feature located on a first edge using said downstream extrusion arrangement,
wherein a middle section between said first edge and a second edge connects said first edge and said second edge,
wherein said first locking feature is at least partially rounded and comprises a diameter that is longer in length than a thickness of said middle section.

26. The method of claim 24, further comprising the steps of:
creating a second locking feature located on said second edge using said downstream extrusion arrangement,
wherein said second locking feature of said second edge comprises a hook configured to hold said first locking feature therein.

27. The method of claim 24, further comprising the steps of:
creating one or more “score and ball” patterns aligned parallel to said first edge and located on said middle section.

28. The method of claim 21, further comprising the steps of:
treating said hemp feedstock in way such that said hemp feedstock becomes a chemically treated hemp feedstock,
wherein said chemically treated hemp feedstock has increased bonding with said binder material.

29. The method of claim 21, wherein one or more of said at least one extrudate layer of said coextruded extrudate sheet is a foamed layer created by said extrudate and a blowing agent, wherein gasses of said blowing agent dissolve into said extrudate prior to ejection from said manifold.

30. The method of claim 29, further comprising the step of:
adding a blowing agent to said extruder in a way such that gasses created by said blowing agent dissolve into said extrudate prior to ejection from said manifold.

31. The method of claim 21, further comprising at least one of carbon, glass fiber, wood fines, and gypsum in said extrudate, wherein said carbon, glass fiber, wood fines, and gypsum are added to said extruder at a point prior to ejection of said extrudate from said manifold.

32. The method of claim 21, further comprising the step of:
adding at least one of carbon, glass fiber, wood fines, and gypsum to said extruder in way such that at least one of said carbon, glass fiber, wood fines, and gypsum are incorporated into said extrudate prior to ejection from said manifold.

33. A method for making a coextruded hemp duct board (CHDB) comprising steps of:
obtaining hemp feedstock comprising at least one of hemp hurd and hemp fiber,
obtaining a binder material comprising at least one of polyolefin, polyethylene, polyamide, and polypropylene,
obtaining a flexible, substrate layer having a first side that forms a first surface,
obtaining an CHB extruding system comprising an extruder, puller, and plurality of rollers,
injecting said hemp hurd, hemp fiber, and binder material into said extruder,
wherein said extruder creates an extrudate using said hemp feedstock and binder material,
wherein a heated barrel of said extruder keeps said extrudate within a desired temperature range,
wherein said desired temperature range is higher than a melting point of said binder material and lower than a combustion point of said hemp hurd and said hemp fiber,
controlling a shear force of said extruder in order to manipulate a viscosity of said extrudate,
wherein said extrudate is expelled from extruder via a die outlet of a manifold at a rate relative to said viscosity,
feeding said flexible, substrate layer to an extrusion arrangement in a way such that said extrudate may be used to coat said first surface of said flexible, substrate layer,
expelling said extrudate from said extruder and onto said first surface of said flexible, substrate layer to create a coextruded extrudate sheet,
wherein said flexible, substrate layer is fed to said extrusion arrangement at a first desired speed and said extrudate is expelled from extruder at a second desired speed,
wherein said first desired speed and said second desired speed dictate a thickness of said extrudate on said first surface of said flexible, substrate layer,
wherein said coextruded extrudate sheet comprises said flexible, substrate layer and at least one extrudate layer, and
molding said coextruded extrudate sheet into shaped CHDB using a downstream extrusion arrangement,
wherein said shaped CHDB has a first locking feature located on a first edge and a second locking feature on a second edge,
wherein a middle section between said first edge and said second edge connects said first edge and said second edge,
wherein said first locking feature is at least partially rounded and comprises a diameter that is longer in length than a thickness of said middle section,
wherein said second locking feature of said second edge comprises a hook configured to hold said first locking feature.

34. The method of claim 33, wherein said flexible, substrate layer comprises at least one of glass, metal, polymer, or natural material.

35. The method of claim 33, further comprising the steps of:
creating a second locking feature located on said second edge,
wherein said second locking feature of said second edge comprises a hook configured to hold a rounded edge feature.

36. The method of claim 33, further comprising the steps of:
creating one or more “score and ball” patterns aligned parallel to said first edge and located on said middle section.

37. The method of claim 33, further comprising the steps of:
treating said hemp feedstock in way such that said hemp feedstock becomes a chemically treated hemp feedstock,
wherein said chemically treated hemp feedstock has increased bonding with said binder material.

38. The method of claim 33, wherein one or more of said at least one extrudate layer of said coextruded extrudate sheet is a foamed layer created by said extrudate and a blowing agent, wherein gasses of said blowing agent dissolve into said extrudate prior to ejection from said manifold.

39. The method of claim 38, further comprising the step of:
adding a blowing agent to said extruder in a way such that gasses created by said blowing agent dissolve into said extrudate prior to ejection from said manifold.

40. The method of claim 33, further comprising at least one of carbon, glass fiber, wood fines, and gypsum in said extrudate, wherein said carbon, glass fiber, wood fines, and gypsum are added to said extruder at a point prior to ejection of said extrudate from said manifold.

41. The method of claim 40, further comprising the step of:
adding at least one of carbon, glass fiber, wood fines, and gypsum to said extruder in way such that at least one of said carbon, glass fiber, wood fines, and gypsum are incorporated into said extrudate prior to ejection from said manifold.

42. A method for a coextruded hemp duct board (CHDB) comprising steps of:
obtaining hemp feedstock comprising at least one of hemp hurd and hemp fiber,
obtaining a binder material comprising at least one of polyolefin, polyethylene, polyamide, and polypropylene,
obtaining a flexible, substrate layer having a first side that forms a first surface,
obtaining an CHB extruding system comprising an extruder, puller, and plurality of rollers,
injecting said hemp hurd, hemp fiber, and binder material into said extruder,
wherein said extruder creates an extrudate using said hemp feedstock and binder material,
wherein a heated barrel of said extruder keeps said extrudate within a desired temperature range,
wherein said desired temperature range is higher than a melting point of said binder material and lower than a combustion point of said hemp hurd and said hemp fiber,
controlling a shear force of said extruder in order to manipulate a viscosity of said extrudate,
wherein said extrudate is expelled from extruder via a die outlet of a manifold at a rate relative to said viscosity,
feeding said flexible, substrate layer to a extrusion arrangement in a way such that said extrudate may be used to coat said first surface of said flexible, substrate layer,
expelling said extrudate from said extruder and onto said first surface of said flexible, substrate layer to create a coextruded extrudate sheet,
wherein said flexible, substrate layer is fed to said extrusion arrangement at a first desired speed and said extrudate is expelled from said extruder at a second desired speed,
wherein said first desired speed and said second desired speed dictate a thickness of said extrudate on said first surface of said flexible, substrate layer,
wherein said coextruded extrudate sheet comprises said flexible, substrate layer and at least one extrudate layer, and
molding said coextruded extrudate sheet into shaped CHDB using a downstream extrusion arrangement,
wherein said shaped CHDB comprises one or more “score and ball” patterns aligned parallel to a first edge and extending from a middle section to said first edge.

43. The method of claim 42, wherein said flexible, substrate layer comprises at least one of glass, metal, polymer, or natural material.

44. The method of claim 42, further comprising the steps of:
creating a first locking feature located on said first edge using said downstream extrusion arrangement,
wherein a middle section between said first edge and a second edge connects said first edge and said second edge,
wherein said first locking feature is at least partially rounded and comprises a diameter that is longer in length than a thickness of said middle section.

45. The method of claim 44, further comprising the steps of:
creating a second locking feature located on said second edge,
wherein said second locking feature of said second edge comprises a hook configured to hold a rounded edge feature.

46. The method of claim 42, further comprising the steps of:
treating said hemp feedstock in way such that said hemp feedstock becomes a chemically treated hemp feedstock,
wherein said chemically treated hemp feedstock has increased bonding with said binder material.

47. The method of claim 42, wherein one or more of said at least one extrudate layer of said coextruded extrudate sheet is a foamed layer created by said extrudate and a blowing agent, wherein gasses of said blowing agent dissolve into said extrudate prior to ejection from said manifold.

48. The method of claim 47, further comprising the step of:
adding a blowing agent to said extrudate in a way such that gasses created by said blowing agent dissolve into said extrudate prior to ejection from said manifold.

49. The method of claim 42, further comprising at least one of carbon, glass fiber, wood fines, and gypsum in said extrudate, wherein said carbon, glass fiber, wood fines, and gypsum are added to said extruder at a point prior to ejection of said extrudate from said manifold.

50. The method of claim 42, further comprising the step of:
adding at least one of carbon, glass fiber, wood fines, and gypsum to said extruder in way such that at least one of said carbon, glass fiber, wood fines, and gypsum are incorporated into said extrudate prior to ejection from said manifold.

51. The method of claim 42, wherein one or more of planing, routing, cutting, or milling (CNC) is used to create at least one of score, ball, or hook features on said coextruded extrudate sheet.
